(19) United States
(12) Patent Application Publication
(10) Pub. No.: US 2009/0204888 A1
(43) Pub. Date: Aug. 13, 2009

(54) DOCUMENT PROCESSING APPARATUS, DOCUMENT PROCESSING METHOD, AND STORAGE MEDIUM

(75) Inventor: Daijiro Miyamoto, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/357,582

(22) Filed: Jan. 22, 2009

(30) Foreign Application Priority Data
Jan. 24, 2008 (JP) 2008-014191

(51) Int. Cl. G06F 17/00

(52) U.S. Cl. 715/243

(57) ABSTRACT

A document processing apparatus performs document editing processing to locate a plurality of objects on a page. The document processing apparatus includes a generation unit configured to generate a synchronization field for an object to be located according to an attribute of any one of the objects located on the page, a retrieval unit configured to retrieve an index object from the page as a target having the attribute to be applied to the generated synchronization field, and a reflecting unit configured to reflect an attribute of the index object retrieved by the retrieval unit and a layout position of the index object in an attribute and a layout position of the object to be located in the synchronization field.

### BACKGROUND OF THE INVENTION

1. Field of the Invention

The present invention relates to a document processing apparatus, which performs document processing for locating a plurality of objects on a page, as well as a document processing method and storage medium therefor.

2. Description of the Related Art

Conventionally, in the process of forming print originals, computer software is available for users to determine a print layout. In general, the software usable to determine a print layout includes the processes of generating a frame to be used to locate text data and locating document data in the frame while adjusting the format of the document data.

The print layout software typically further includes the processes of analyzing the content of uploaded electronic data and performing editing processing (e.g., deletion, addition, and shifting) on each object to be processed, which includes a recognized text or an image.

Thus, the print layout software can be flexibly used to correct and change the uploaded electronic data.

For example, in the variable printing to be performed to output print products dedicated to individual clients, a text or an image to be replaced for each user is input to a field (e.g., frame) included in original data.

In this case, if a replacement text (a text to be replaced) and a text object located beforehand in the original data are combined as a united part of a document (e.g., name+Esq.), the position and the font of the replacement text may be required to be adjusted according to the text of the original data.

A conventional method for adjusting the position includes selecting a plurality of objects to be positioned and performing an alignment operation, such as “top alignment” or “left alignment”, to locate the objects along their frames.

As discussed in Japanese Patent Application Laid-Open No. 7-105212, another method for adjusting the position includes aligning an object relative to an arbitrary point in the frame, not the frame itself.

However, the adjustment realized by the above-described conventional methods is limited to the positional alignment of respective objects. The text attributes typically cannot be adjusted between the objects. For example, if the top alignment is set for texts to be placed in a plurality of fields, the text can be aligned along the top side of each field.

However, if texts to be input in respective fields are mutually different in their font size, the bottom positions of respective texts are not uniformly aligned. Therefore, user's manual work for unifying the font size may be additionally required.

### SUMMARY OF THE INVENTION

According to an aspect of the present invention, a document processing apparatus performs document editing processing to locate a plurality of objects on a page. The document processing apparatus includes a generation unit configured to generate a synchronization field for an object to be located according to an attribute of any one of the objects located on the page, a retrieval unit configured to retrieve an index object from the page as a target having the attribute to be applied to the generated synchronization field, and a reflecting unit configured to reflect an attribute of the index object retrieved by the retrieval unit and a layout position of the index object in an attribute and a layout position of the object to be located in the synchronization field.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments and features of the invention and, together with the description, serve to explain at least some of the principles of the invention.

FIG. 1 illustrates a software configuration of a document processing system according to a first exemplary embodiment of the present invention.

FIG. 2 is a block diagram illustrating an embodiment of a hardware configuration of a computer illustrated in FIG. 1.

FIGS. 3A and 3B illustrate an electronic original data structure, which can be processed by an information processing apparatus, according to an exemplary embodiment of the present invention.

FIG. 4 illustrates an embodiment of a list of book attributes illustrated in FIG. 3A.

FIG. 5 illustrates an embodiment of a list of chapter attributes illustrated in FIG. 3A.

FIG. 6 illustrates an embodiment of a list of page attributes illustrated in FIG. 3A.

FIG. 7 is a flowchart illustrating an example procedure of data processing, which can be performed by a document processing apparatus, according to an exemplary embodiment of the present invention.

FIG. 8 is a flowchart illustrating an example procedure of data processing, which can be performed by the document processing apparatus, according to an exemplary embodiment of the present invention.

FIG. 9 is a flowchart illustrating an example procedure of data processing, which can be performed by the document processing apparatus, according to an exemplary embodiment of the present invention.

FIG. 10 illustrates an embodiment of a user interface, which can be displayed on a cathode ray tube (CRT) illustrated in FIG. 2.

FIG. 11 illustrates an embodiment of a user interface, which can be displayed on the CRT illustrated in FIG. 2.

FIG. 12 is a block diagram illustrating a document processing system according to an exemplary embodiment of the present invention.

FIG. 13 is a block diagram illustrating an example document processing system according to an exemplary embodiment of the present invention.

FIG. 14 illustrates an example user interface, which can be displayed on the CRT illustrated in FIG. 2.

FIG. 15 is a flowchart illustrating an example procedure of data processing, which can be performed by the document processing apparatus, according to an exemplary embodiment of the present invention.

FIG. 16 illustrates an example user interface, which can be displayed on the CRT illustrated in FIG. 2.

FIG. 17 illustrates an example user interface, which can be displayed on the CRT illustrated in FIG. 2.

FIG. 18 is a flowchart illustrating an example procedure of data processing, which can be performed by the document processing apparatus, according to an exemplary embodiment of the present invention.

FIG. 19 illustrates an example user interface, which can be displayed on the embodiment of the CRT illustrated in FIG. 2.

FIG. 20 illustrates an example user interface, which can be displayed on the embodiment of the CRT illustrated in FIG. 2.

FIG. 21 illustrates an example user interface, which can be displayed on the embodiment of the CRT illustrated in FIG. 2.

FIG. 22 is a flowchart illustrating an example procedure of data processing, which can be performed by the document processing apparatus, according to an exemplary embodiment of the present invention.

FIG. 23 illustrates an example user interface, which can be displayed on the embodiment of the CRT illustrated in FIG. 2.

FIG. 24A illustrates an example user interface, which can be displayed on the embodiment of the CRT illustrated in FIG. 2.

FIG. 24B illustrates example document editing processing, which can be performed by the document processing apparatus, according to an exemplary embodiment of the present invention.

FIG. 24C illustrates example document editing processing, which can be performed by the document processing apparatus, according to an exemplary embodiment of the present invention.

FIG. 25 illustrates an example logical page including a text object, which can be processed by the information processing apparatus, according to an exemplary embodiment of the present invention.

FIG. 26 illustrates an example data structure of a text object, which can be processed by the information processing apparatus, according to an exemplary embodiment of the present invention.

FIG. 27 is a flowchart illustrating an example procedure of data processing, which can be performed by the document processing apparatus, according to an exemplary embodiment of the present invention.

FIG. 28 is a flowchart illustrating an example procedure of data processing, which can be performed by the document processing apparatus, according to an exemplary embodiment of the present invention.

FIG. 29A illustrates a relationship in data structure between an index object and a synchronization object, which can be processed by the information processing apparatus, according to an exemplary embodiment of the present invention.

FIG. 29B illustrates an example of index object retrieval processing described with reference to the flowchart illustrated in FIG. 28.

FIG. 29C illustrates an example of the index object retrieval processing described with reference to the flowchart illustrated in FIG. 28.

FIG. 29D illustrates an example of the index object retrieval processing described with reference to the flowchart illustrated in FIG. 28.

FIG. 29E illustrates an example of the index object retrieval processing described with reference to the flowchart illustrated in FIG. 28.

FIG. 30 illustrates an example relationship in data structure between an index object and a synchronization object, which can be processed by the information processing apparatus, according to an exemplary embodiment of the present invention.

FIG. 31 is a flowchart illustrating an example procedure of data processing, which can be performed by the document processing apparatus, according to an exemplary embodiment of the present invention.

FIG. 32 illustrates example document editing processing performed on a user interface, which can be displayed on the embodiment of the CRT of FIG. 2.

FIG. 33 illustrates an example state of a text object subjected to a highlight setting, which can be performed by the information processing apparatus, according to an exemplary embodiment of the present invention.

FIG. 34 illustrates an example state of the text object subjected to the highlight setting, which can be performed by the information processing apparatus, according to an exemplary embodiment of the present invention.

FIG. 35 is a flowchart illustrating an example procedure of data processing, which can be performed by the document processing apparatus, according to an exemplary embodiment of the present invention.

FIGS. 36A and 36B illustrate example states in the object position change processing performed by the information processing apparatus according to an exemplary embodiment of the present invention.

FIGS. 37A to 37C illustrate example states in the object position change processing performed by the information processing apparatus according to an exemplary embodiment of the present invention.

FIGS. 38A1 and 38A2 illustrate example states in the object editing processing performed by the information processing apparatus according to an exemplary embodiment of the present invention.

FIG. 38B illustrates an example state in the object editing processing performed by the information processing apparatus according to an exemplary embodiment of the present invention.

FIG. 39 illustrates an example state in the object editing processing performed by the information processing apparatus according to an exemplary embodiment of the present invention.

FIG. 40A is a flowchart illustrating an example procedure of data processing, which can be performed by the document processing apparatus, according to an exemplary embodiment of the present invention.

FIG. 40B is a flowchart illustrating an example procedure of data processing, which can be performed by the document processing apparatus, according to an exemplary embodiment of the present invention.

FIG. 40C illustrates an example state in the object editing processing performed by the information processing apparatus according to an exemplary embodiment of the present invention.

FIG. 40D illustrates an example state in the object editing processing performed by the information processing apparatus according to an exemplary embodiment of the present invention.

FIGS. 41A and 41B illustrate example states in synchronization field shift processing performed by the information processing apparatus according to an exemplary embodiment of the present invention.

FIGS. 42A and 42B illustrate example states in the synchronization field shift processing performed by the information processing apparatus according to an exemplary embodiment of the present invention.

FIG. 43 illustrates an example user interface, which can be displayed on the embodiment of the CRT of FIG. 2.

FIG. 44 illustrates page layout examples to be used in the variable printing, performed by the document processing system, according to an exemplary embodiment of the present invention.

FIG. 45A illustrates an example user interface, which can be displayed on the embodiment of the CRT of FIG. 2.

FIG. 45B illustrates an example user interface, which can be displayed on the embodiment of the CRT of FIG. 2.

FIG. 46A illustrates an example user interface, which can be displayed on the embodiment of the CRT of FIG. 2.

FIG. 46B illustrates an example user interface, which can be displayed on the embodiment of the CRT of FIG. 2.

FIG. 47 illustrates an example state in the document processing performed by the document processing apparatus according to an exemplary embodiment of the present invention.

FIG. 48 is a flowchart illustrating an example procedure of data processing, which can be performed by the document processing apparatus, according to an exemplary embodiment of the present invention.

FIG. 49 illustrates a memory map of a storage medium, which can store various data processing programs readably by the document processing apparatus, according to an exemplary embodiment of the present invention.

### DETAILED DESCRIPTION OF THE EMBODIMENTS

The following description of exemplary embodiments is illustrative in nature and is in no way intended to limit the invention, its application, or uses. It is noted that throughout the specification, similar reference numerals and letters refer to similar items in the following figures, and thus once an item is described in one figure, it may not be discussed for following figures. Exemplary embodiments will be described in detail below with reference to the drawings.

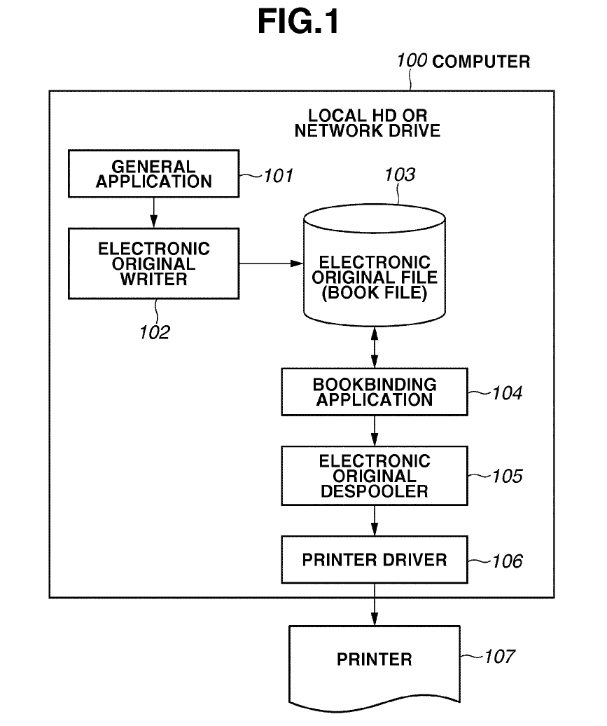

FIG. 1 illustrates a software configuration of a document processing system according to an exemplary embodiment of the present invention. The document processing system according to this embodiment includes an electronic original writer that can convert a data file generated by a general application into an electronic original file and a bookbinding application that enables users to edit an electronic original file.

The bookbinding application according to this embodiment has the capability of creating and editing a document of electronic data generated by an electronic original writer, and provides improved operability to effectively perform document editing processing. The document processing system can be realized by a computer 100 (hereinafter, referred to as a “host computer”), which can function as an information processing apparatus according to aspects of the present invention.

In the embodiment as shown in FIG. 1, the general application 101 may provide various functions, such as word processing, spread sheet, photo retouch, presentation, and text editing. The general application 101 may also have a print function for an operating system (OS).

When a user instructs printing of generated application data (i.e., document data, image data, etc.), the general application 101 may use a predetermined interface (generally, referred to as “Graphics Device Interface (GDI)”) provided by the OS.

Namely, to print generated data, the general application 101 can transmit an output command (GDI function) having an OS-dependent format to an output module of the OS that provides the above-described interface.

The output module receives the output command and converts the received output command into data having a format that can be processed by a printer or other output device. The output module outputs a converted command (referred to as Device Driver Interface (DDI) function). The format that the output device can process is dependent on the type of each device, each manufacturer, and each machine model.

The OS converts the command using the device driver, generates print data, and generates a print job using a job language (JL).

When the OS is Windows® provided by Microsoft Corporation, the above-described output module is referred to as Graphic Device Interface (GDI).

An electronic original writer 102, serving as an improved device driver, is a software module that can realize a document processing system according to an exemplary embodiment according to the present invention.

The electronic original writer 102 is not dedicated to a specific output device, and generates an electronic original file 103 based on conversion of data into an output command having a predetermined format so that a bookbinding application 104 or a printer driver 106 can process the output command.

The converted format obtained by the electronic original writer 102 (hereinafter, referred to as an “electronic original format”) can be any format that can express original data on a page-by-page basis. For example, Portable Document Format (PDF) format provided by Adobe® Systems or Scalable Vector Graphics (SVG) format can be used as a standard electronic original format.

In one version, when the general application 101 uses the electronic original writer 102, the general application 101 may designate the electronic original writer 102 as an output device driver before instructing print processing.

In general, an electronic original file generated by the electronic original writer 102 does not have perfect format as an electronic original file. Therefore, the bookbinding application 104 may designate the electronic original writer 102 as a device driver. The bookbinding application 104 can manage the conversion of application data into an electronic original file.

According to one embodiment, the bookbinding application 104 then completes an electronic original file so as to have a later-described format based on an incomplete electronic original file newly generated by the electronic original writer 102.

In the following description, to explicitly express the above-described features, a file generated by the electronic original writer 102 may be referred to as an “electronic original file” and an electronic original file having been completed by the bookbinding application 104 may be referred to as a “book file.” In the embodiment shown in FIG. 1, the book file corresponds to the electronic original file 103.

If the files are not specifically discriminated, then document files, electronic original files, and book files generated by an application may be simply referred to as document files (or document data).

As described above, when the electronic original writer 102 is designated as a device driver and the general application 101 generates print data, application data can be converted into an electronic original format including pages (hereinafter, referred to as a “logical page” or an “original page”) defined by the general application 101. The converted application data can be stored as the electronic original file 103 into a hard disk or other storage medium.

The hard disk can be, for example, a local drive of the computer 100 that realizes the document processing system of the present exemplary embodiment, or can be a network drive connected to a network.

In one embodiment, the bookbinding application 104 may read the electronic original file (or book file) 103 and enables users to edit the read file.

However, the bookbinding application 104 may not provide any function for editing the content of each page. In one version, the bookbinding application 104 enables users to edit the structure of a book including chapters on a page-by-page basis.

In the embodiment as shown in FIG. 1, when a user instructs printing of the book file 103 edited by the bookbinding application 104, the bookbinding application 104 activates an electronic original despooler 105.

The electronic original despooler 105 may be a program module to be installed on the computer together with the bookbinding application 104.

The electronic original despooler 105 is a module capable of outputting rendering data to the printer driver 106, when a document (book file) to be used by the bookbinding application 104 is printed.

In one version, the electronic original despooler 105 reads a designated book file from the hard disk, and generates an output command adaptable to the above-described output module of the OS so as to print each page according to a format described in the book file. The electronic original despooler 105 outputs the generated command to the output module (not illustrated).

In this case, the electronic original despooler 105 designates the printer driver 106 as a device driver for a printer 107 used as an output device.

The output module converts the received output command into a device command and outputs the device command to the printer driver 106 to be used by the designated printer 107. The printer driver 106 converts the received device command into a command, such as a page description language, which can be interpreted by the printer 107.

Then, the printer driver 106 transmits the converted device command to the printer 107 via a system spooler (not illustrated). The printer 107 prints an image based on the command.

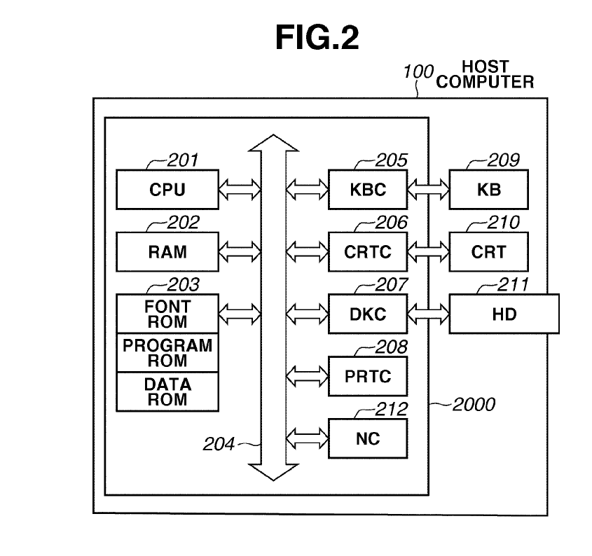

FIG. 2 is a block diagram illustrating an example hardware configuration of the computer 100 illustrated in FIG. 1.

In the embodiment shown in FIG. 2, a central processing unit (CPU) 201 executes various computer programs, including for example the OS, the general application 101, and the bookbinding application 104, which can be loaded into a random access memory (RAM) 202 from a read-only memory (ROM) 203 (a program ROM) or a hard disk (HD) 211.

Furthermore, the CPU 201 can realize the software configuration illustrated in FIG. 1 and the procedures of later-described flowcharts.

The RAM 202 is capable of functioning as a main memory and a work area for the CPU 201. A keyboard controller (KBC) 205 controls any key input entered through a keyboard (KB) 209 or a pointing device (not illustrated).

A cathode ray tube (CRT) controller (CRTC) 206 controls a cathode ray tube (CRT) 210. A disk controller (DKC) 207 controls any access to the HD 211 or a floppy disk (FD), which can store, for example, at least one of a boot program, various applications, font data, user files, and later-described editing files. The above-described functional units 201-203 and 205-207 and below-described units 204, 208, and 212 may together constitute a controller unit 2000.

A printer controller (PRTC) 208 controls signals sent to or received from the connected printer 107. A network controller (NC) 212, connected to a network, executes communication control processing when the computer 100 communicates with other devices connected to the network.

Prior to a detailed description of the bookbinding application 104, an example data format of the above-described “book file” is described below.

The book file has a three-layer structure resembling a book composed of papers.

An upper layer is referred to as a “book” resembling a single book, which can define an attribute relating to the entire book. An intermediate layer, subordinated to the upper layer, is referred to as a “chapter” that corresponds to a chapter of the book. Each “chapter” can define an attribute of each chapter. A lower layer is referred to as a “page” that corresponds to each page defined by an application program.

Each “page” can define an attribute of each page. One “book” can include a plurality of “chapters”. One “chapter” can include a plurality of “pages”.

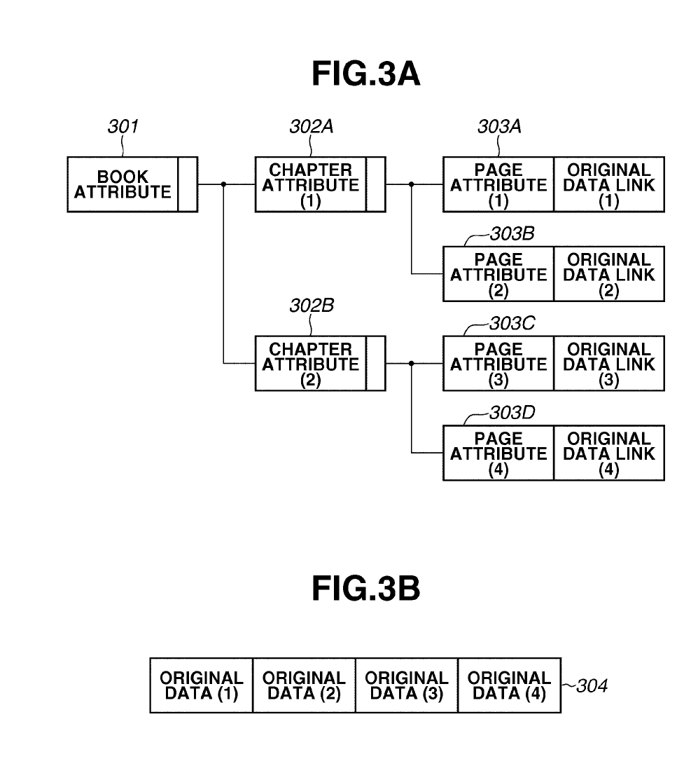

FIGS. 3A and 3B illustrate an example of an electronic original data structure, which can be processed by an information processing apparatus, according to the present exemplary embodiment. FIG. 3A illustrates an example format of the book file including a book, chapters, and pages denoted by corresponding nodes according to the present exemplary embodiment.

One book file includes one “book.” Both the “book” and the “chapter” are the concept that defines a book structure and include defined attribute values and a link to a lower layer as its entity.

The “page” includes data for each page generated by the application program as its entity. Therefore, the “page” includes the entity of an original page (i.e., original page data) and a link to each original page data, in addition to its attribute values.

A print page output to a paper medium may include a plurality of original pages. The structure of each print page is not displayed with a link and displayed as part of the attributes for the “book”, the “chapter”, or the “page.”

In FIG. 3A, a book 301 defines its attribute (book attribute) and includes two chapters 302A and 302B linked together.

The chapter 302A includes two pages 303A and 303B linked together. The page 303A defines its attribute value (1) and includes a link to corresponding original page data (1). The page 303B defines its attribute value (2) and includes a link to corresponding original page data (2). The original page data is the entity of each page. Similarly, the chapter 302B includes two pages 303C and 303D linked together. The page 303C defines its attribute value (3) and includes a link to corresponding original page data (3). The page 303D defines its attribute value (4) and includes a link to corresponding original page data (4).

FIG. 3B illustrates example original page data 304 including the original page data (1) to (4) representing the entities of pages 303A, 303B, 303C and 303D.

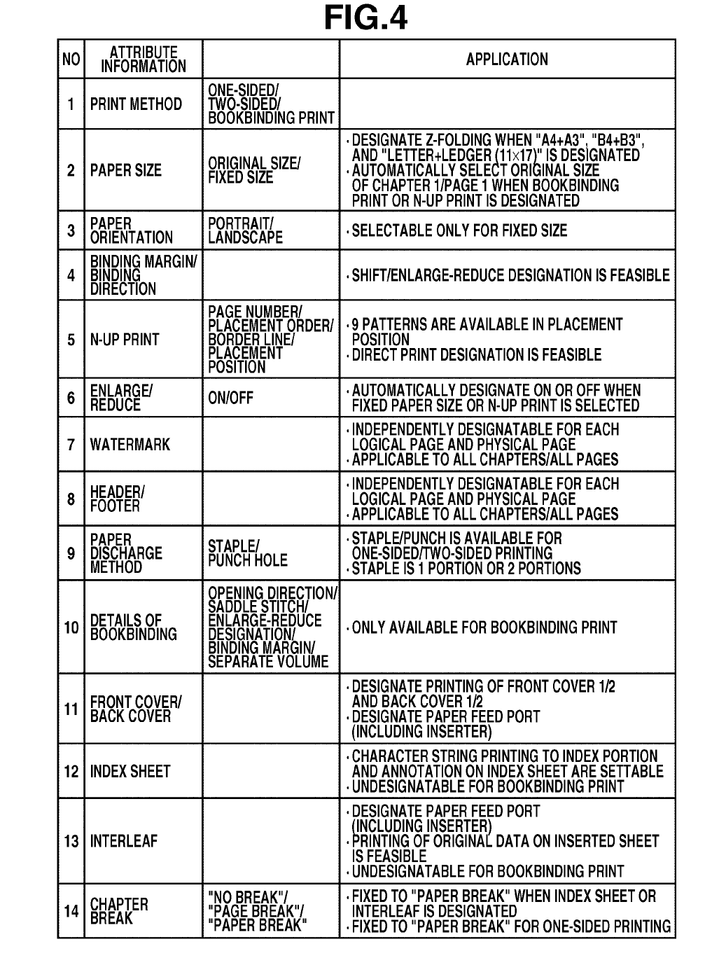

FIG. 4 illustrates an example list of the book attributes 301 illustrated in FIG. 3A. An item, if defined in both upper and lower layers, describes its effective attribute value in the lower layer. Therefore, an item involved only in the book attribute 301 has an attribute value that is valid in the entire book.

However, an item defined in both the book attribute and a lower layer has a valid content being set for the book attribute. In the example illustrated in FIG. 4, each item may not correspond to a single item and may include a plurality of relevant items.

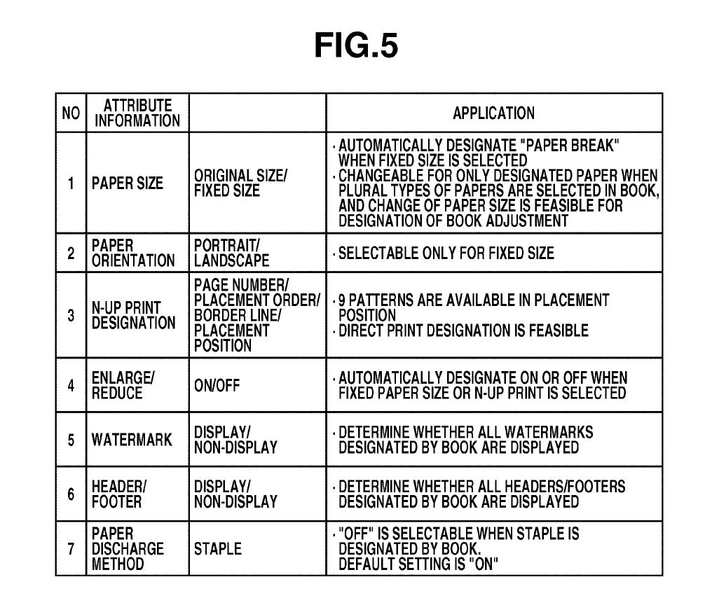

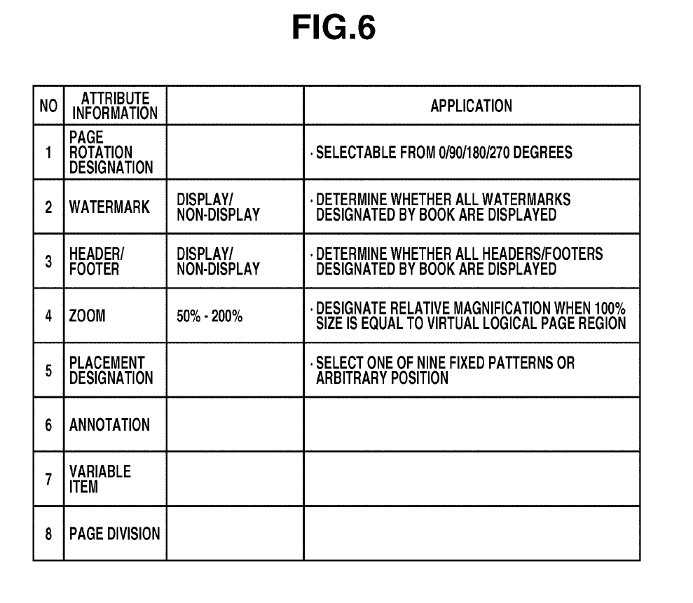

FIG. 5 illustrates an example list of the chapter attributes illustrated in FIG. 3A. FIG. 6 illustrates an example list of the page attributes illustrated in FIG. 3A. The relationship between the chapter attributes and the page attributes is similar to the relationship between the book attributes and lower layer attributes.

As is apparent from FIGS. 4 to 6, a total of seven items of “print method”, “binding margin/binding direction”, “details of bookbinding”, “front cover/back cover”, “index sheet”, “interleaf”, and “chapter break” are items unique to the book attributes 301 and defined as valid throughout the book.

The “print method” attribute enables users to designate, as a print method, “one-sided print”, “two-sided print”, or “bookbinding print.” The “bookbinding print” is a predetermined print method prepared beforehand to form a book through sequential processes including bundling a designated number of sheets, folding the sheets, and stitching the sheets.

The “binding margin/binding direction” attribute enables users to designate the width of a margin for binding and the binding direction (e.g., “long edge” or “short edge”) The “details of bookbinding” attribute enables users to designate “opening direction”, “total number of bundled sheets”, or the like when the user selects the bookbinding printing.

The “front cover/back cover” attribute enables users to add a front cover and a back cover for an electronic original file to be printed as a book and designate print contents on the added covers.

The “index sheet” attribute enables users to designate an insertion of an eared index sheet, as a break of a chapter, which can be separately prepared for a printing apparatus and also enables users to designate print contents on the index eared portions.

The “index sheet” attribute may be valid for a printing apparatus equipped with an inserter that can insert a specially provided sheet into a predetermined position of the printed papers. The “index sheet” attribute may also be valid when a printer has a plurality of paper feed cassettes. The same thing may be applied to the “interleaf” attribute.

The “interleaf” attribute enables users to designate, as a break of a chapter, insertion of a sheet supplied by an inserter or from a paper feed cassette and, if an interleaf is inserted, designate a paper feeding source.

The “chapter break” attribute enables users to designate the usage of a new paper or the usage of a new print page at a breakpoint of the chapter.

When a user selects the “one-sided printing”, usage of a new paper and usage of a new print page are not different in the meaning. If a user designates the “usage of a new paper” in the two-sided printing, consecutive chapters are not printed on the same paper. On the other hand, if a user designates the “usage of a new print page”, consecutive chapters can be printed on front and back surfaces of a paper.

The chapter attributes illustrated in FIG. 5 do not include any item(s) unique to the chapter. All of the chapter attributes are involved in the book attributes.

Therefore, if definitions in the chapter attributes disagree with definitions in the book attributes, the values defined in the chapter attribute are prioritized over the values defined in the book attributes.

Five items of “paper size”, “paper orientation”, “N-up print designation”, “enlarge/reduce”, and “paper discharge method” are items commonly included in the book attributes and the chapter attributes.

The “N-up print designation” attribute is an item enabling users to designate the number of original pages on a piece of printed paper. For example, a user can select a page layout selected from the group including 1×1, 1×2, 2×2, 3×3, and 4×4.

The “paper discharge method” attribute is an item enabling users to determine whether staple processing for discharged sheets is performed, although the “paper discharge method” attribute may be valid for a printing apparatus having a stapling function.

In FIG. 6, five items of “page rotation designation”, “zoom”, “placement designation”, “annotation”, and “page division” are items unique to the page attributes. The “page rotation designation” attribute is an item enabling users to designate a rotational angle of an original page to be disposed on a print page. The “zoom” attribute is an item enabling users to designate a zoom ratio of an original page. The zoom ratio defines a size relative to a virtual logical page region (i.e., 100%). The virtual logical page region is a region occupied by one original page when the original page is disposed according to an N-up designation.

For example, if the selected page layout is 1×1, the virtual logical page region is a region corresponding to one printed page. If the selected page layout is 1×2, the virtual logical page region is a reduced region having each side equivalent to approximately 70% of a corresponding side of one printed page.

Two attribute items “watermark” and “header/footer” are commonly included in the “book”, “chapter”, and “page” attributes. The “watermark” is an image or a character string which can be superposed on print data generated by an application.

The “header/footer” is information in a top margin and/or a bottom margin to be printed on each page. The “header/footer” can include any parameters, such as a page number and date/time, which are variable.

The contents designated in the “watermark” attribute and the “header/footer” attribute are similarly defined in the chapter attributes and the page attributes. The “book” attributes are different from the “chapter” attributes and the “page” attributes.

The “book” attributes can define the contents of the “watermark” and the “header/footer” and also designate print methods of the “watermark” and the “header/footer” throughout the book.

On the other hand, the “chapter” attributes and the “page” attributes can determine whether the “watermark” and the “header/footer” defined in the book attributes are applied to each “chapter” or each “page.”

Embodiments of the “book file” may have at least a portion of the above-described structure and contents.

In one version, the bookbinding application 104 and the electronic original writer 102 may generate a book file according to the following procedure. The book file generation procedure may be a part of a book file editing operation performed by the bookbinding application 104.

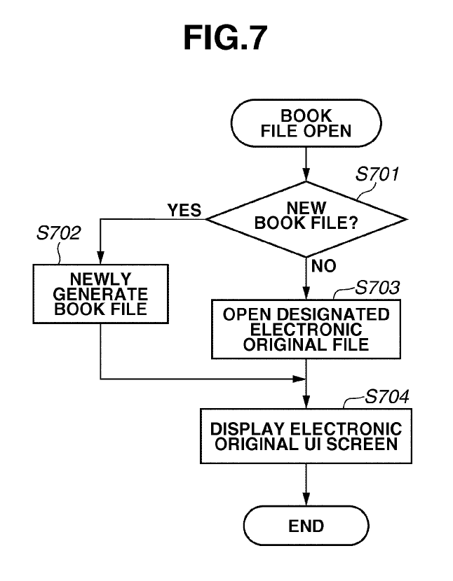

FIG. 7 is a flowchart illustrating an example procedure of data processing, which can be performed by a document processing apparatus, according to the present exemplary embodiment. More specifically, the processing illustrated in FIG. 7 may be performed by the bookbinding application 104 illustrated in FIG. 1 when the bookbinding application 104 opens a book file. To realize each step of the flowchart, the CPU 201 illustrated in FIG. 2 may execute the bookbinding application 104 loaded in the RAM 202.

In step S701, the bookbinding application 104 determines whether a book file to be opened (i.e., target file) is a new file or an already existing file. If the bookbinding application 104 determines that the book to be opened is a new file (YES in step S701), the processing proceeds to step S702. In step S702, the bookbinding application 104 newly generates A book file including no chapter. Then, the processing proceeds to step S704.

According to the example illustrated in FIG. 3A, a newly generated book file has only the book node 301 and does not have any link to a chapter node. A set of book attributes for a new book file can be prepared beforehand.

In step S704, the bookbinding application 104 displays a user interface (UI) screen to enable a user to edit a new book file and terminates the processing routine illustrated in FIG. 7.

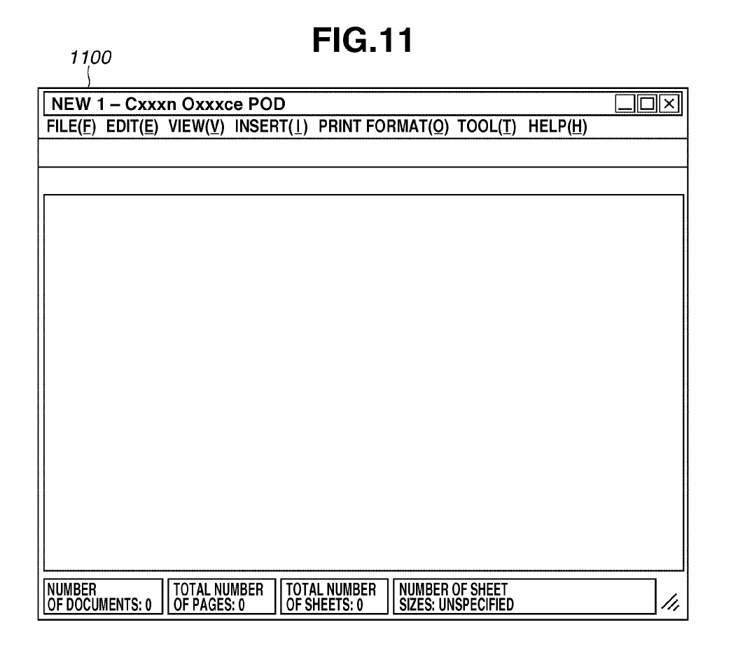

FIG. 11 illustrates an example of a user interface to be displayed on the embodiment of the CRT 210 illustrated in FIG. 2. The user interface illustrated in FIG. 11 is an example UI screen to be displayed when a book file is newly generated. In this case, the new book file has no substantial content and, therefore, nothing is displayed on a UI screen 1100.

On the other hand, if the bookbinding application 104 determines that the opened book is an already existing file (NO in step S701), the processing proceeds to step S703. In step S703, the bookbinding application 104 opens the designated electronic original file. In step S704, the bookbinding application 104 displays a user interface (UI) screen according to the structure, attributes, and contents of the designated book file, and terminates the processing routine illustrated in FIG. 7.

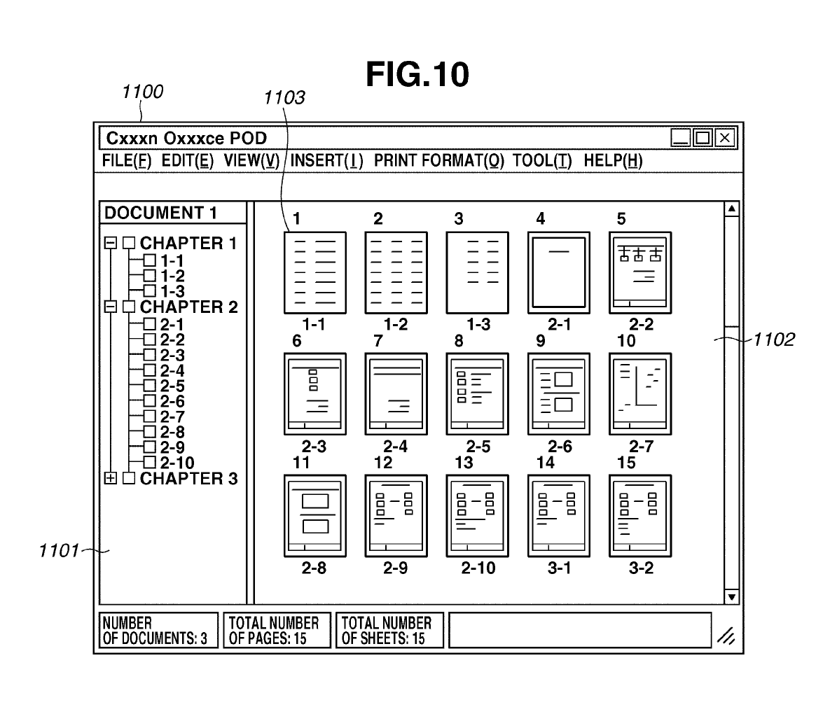

FIG. 10 illustrates an example of a user interface, which can be displayed on the embodiment of the CRT 210 illustrated in FIG. 2. The user interface illustrated in FIG. 10 is an example UI screen, which displays a book file designated from existing book files.

In FIG. 10, the UI screen 1100 includes a tree section 1101 that indicates a book structure and a preview section 1102 that displays a state of printed pages. The tree section 1101 displays all chapters included in the book and pages included in each chapter to form a tree structure as illustrated in FIG. 3A.

The page displayed in the tree section 1101 is a page of the original. The preview section 1102 displays a reduced image 1103 of each printed page. The display order in the preview section 1102 reflects the structure of a book.

In one version, any application data converted into an electronic original file by the electronic original writer 102 can be added, as a new chapter, to the opened book file. This function is referred to as an “electronic original import function.”

When an electronic original is imported to the book file newly generated according to the procedure illustrated in FIG. 7, the book file can possess a substantial entity.

The electronic original import function can be activated when a user drags and drops any application data on the UI screen illustrated in FIG. 10.

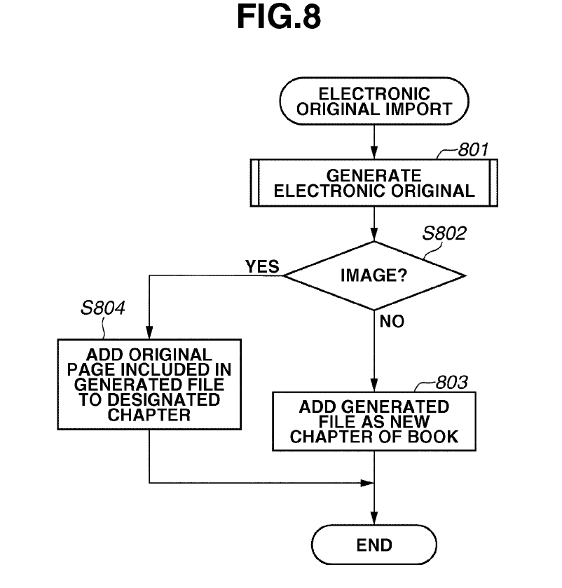

FIG. 8 is a flowchart illustrating an example procedure of data processing, which can be performed by the document processing apparatus, according to the present exemplary embodiment. FIG. 8 illustrates an example procedure for importing an electronic original, which can be performed for example by the electronic original writer 102 illustrated in FIG. 1, according to the present exemplary embodiment.

First, in step S801, the CPU 201 activates an application program that has generated designated application data and causes the electronic original writer 102, which is designated as a device driver, to generate electronic original data through print processing of the application data. In step S802, the electronic original writer 102 determines whether the generated data is image data, for example, based on a file extension of the application data if the OS is Windows®.

For example, if the extension is “bmp”, the electronic original writer 102 can determine that the generated data is Windows® bitmap data. If the extension is “jpg”, the electronic original writer 102 can determine that the generated data is Joint Photographic Experts Group (JPEG) compression image data. If the extension is “tiff”, the electronic original writer 102 can determine that the generated data is Tagged Image Format (TIFF) image data.

If the generated data is image data, the electronic original writer 102 can directly generate an electronic original file based on the image data without activating any application (in step S801). Namely, the processing of step S801 can be omitted.

If the electronic original writer 102 determines that the generated data is not image data (NO in step S802), the processing proceeds to step S803. In step S803, the electronic original writer 102 adds the electronic original file generated in step S801 to the presently opened book file as a new chapter of the book and terminates the processing routine illustrated in FIG. 8.

In this case, if items are commonly defined for the book attributes and the chapter attributes, the electronic original writer 102 can copy attribute values of the book attributes for the chapter attributes. Otherwise, the electronic original writer 102 may set default values prepared beforehand.

If the electronic original writer 102 determines that the generated data is image data (YES in step S802), the processing proceeds to step S804. In step S804, the electronic original writer 102 does not add any new chapter. The electronic original writer 102 adds each original page of the electronic original file generated in step S801 to a designated chapter and terminates the processing routine illustrated in FIG. 8.

However, if a new book file is generated, a new chapter is generated and each page of an electronic original file is added as a page belonging to this chapter.

The page attributes may include attribute values commonly used for the page attributes and upper layer attributes or attribute values defined by application data if continuously used for an electronic original file.

For example, if “N-up designation” is designated in the application data, its attribute values can be continuously used. In this manner, a new book file may be generated or a new chapter may be added.

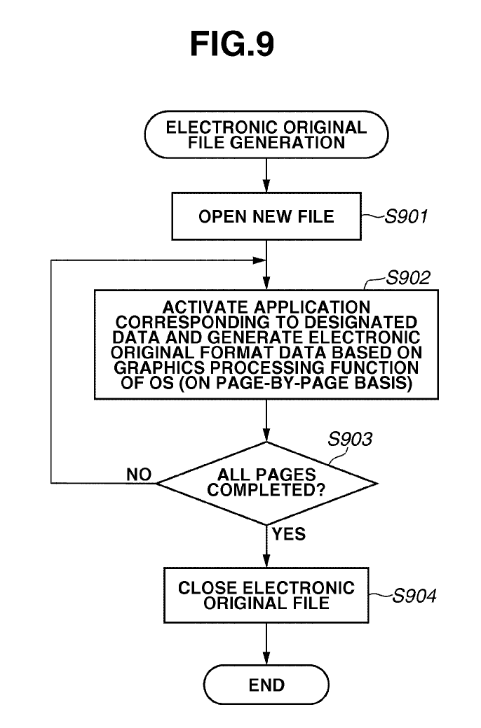

FIG. 9 is a flowchart illustrating an example procedure of data processing, which can be performed by the document processing apparatus, according to the present exemplary embodiment. FIG. 9 illustrates an example procedure that may be performed by the electronic original writer 102 in step S801 of FIG. 8 to generate an electronic original file.

In step S901, the electronic original writer 102 generates and opens a new electronic original file. In step S902, the electronic original writer 102 activates an application corresponding to the designated application data and transmits an output command to an output module of the OS while designating the electronic original writer 102 as a device driver. The output module causes the electronic original writer 102 to convert the received output command into electronic original format data, and outputs the converted data to the electronic original file opened in step S901.

In step S903, the electronic original writer 102 determines whether the conversion processing has been completed for all designated data. If the electronic original writer 102 determines that the conversion processing for all designated data has been completed (YES in step S903), the processing proceeds to step S904. In step S904, the electronic original writer 102 closes the electronic original file and terminates the processing routine illustrated in FIG. 9. If the electronic original writer 102 determines that the conversion processing for all designated data has not been completed (NO in step S903), the processing flow returns to step S902.

An electronic original file generated by the electronic original writer 102 may be a file that includes the entity of the original page data illustrated in FIG. 3B.

The present exemplary embodiment may allow users to perform the following editing operations for each chapter and each page of a book file generated based on application data as described above.

(1) new addition
(2) deletion
(3) copy
(4) cut
(5) paste
(6) shift
(7) change of chapter name
(8) renumber/rename of page
(9) cover insertion
(10) interleaf insertion
(11) index sheet insertion
(12) original page layout

The present exemplary embodiment allows users to cancel an editing operation after having been previously set, or allows users to instruct execution of a previously canceled operation.

In short, the editing functions according to aspects of the present exemplary embodiment enable a user to perform various operations including, for example, integration of a plurality of book files, relocation of chapters and pages in a book file, deletion of chapters and pages in a book file, layout change of an original page, and insertion of an interleaf or an index sheet.

If a user performs the above-described operations, the system according to the present exemplary embodiment may reflect the operation result to the attributes illustrated in FIGS. 4 and 5 or may change the structure of a book file. For example, if a user instructs addition of a new blank page, the system according to the present exemplary embodiment can insert a blank page to at a designated portion.

The inserted blank page is regarded as an original page. If a user changes the layout of an original page, the system according to the present exemplary embodiment reflects the changed contents as part of the attributes (e.g., print method, N-up print, front cover/back cover, index sheet, interleaf, and chapter break).

A book file having been generated/edited as described above is printed as a final output.

In one version, if a user selects a file menu from the UI screen 1100 of the bookbinding application illustrated in FIG. 10 and designates printing of the selected file name, a designated output device prints out the selected file.

In this case, the bookbinding application 104 may generate a job ticket based on the presently opened book file and transmit the generated job ticket to the electronic original despooler 105.

The electronic original despooler 105 can receive the job ticket and convert the received ticket into an output command of the OS (e.g., GDI command of Windows®) and transmit the output command to an output module (e.g., GDI). The output module generates a command suitable to the output device with the designated printer driver 106 and transmits the generated command to the output device.

The job ticket may have a data structure including original pages (minimum units). The data structure of a job ticket can define the layout of original pages on a paper. One job ticket can be issued for one job. Therefore, a job ticket may include an uppermost-layer node “document” which defines attributes of the entire document, such as two-sided print/one-sided print. Paper nodes, each subordinating to the document node, can include an identifier of paper to be used and designation of a paper feed port of a printer. A node of a sheet printed with the paper may belong to each paper node.

One sheet corresponds to a piece of printing paper. A printed page (i.e., a physical page) belongs to each sheet. If the print method is the one-sided print, one physical page belongs to one sheet. If the print method is the two-sided print, two physical pages belong to one sheet. A disposed original page belongs to each physical page.

Furthermore, attributes for a physical page can include the layout of an original page.

The electronic original despooler 105 can convert the above-described job ticket into a command to be supplied to the output module.

As described above, the document processing system according to the present exemplary embodiment may be a stand-alone type. Generation and editing of book files can also be realized by a similar arrangement and procedure even if the present exemplary embodiment is applied to an expanded server-client system, although the book files and print processing may be managed by the server.

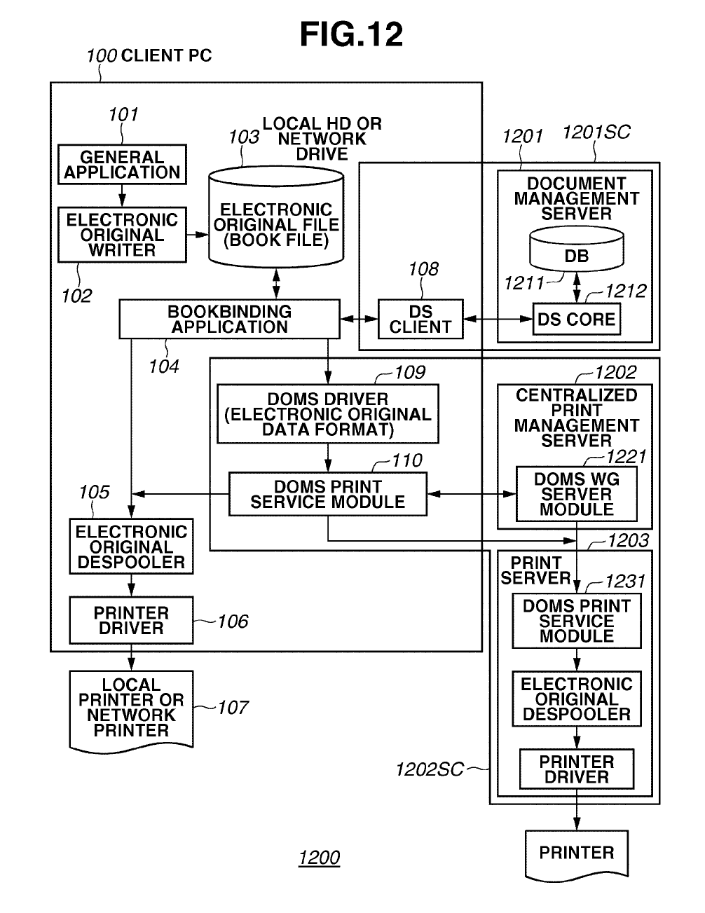

FIG. 12 is a block diagram illustrating an exemplary configuration of the document processing system according to the present exemplary embodiment. The present exemplary embodiment describes an example configuration of a server-client type document processing system 1200.

The embodiment of the client document processing system 1200 illustrated in FIG. 12 includes a document output management service (DOMS) driver 109, which serves as a client module, in addition to the arrangement of a stand-alone type system.

The client document processing system 1200 further includes a DOMS print service module 110 and a document service (DS) client 108.

The client document processing system 1200 is connected to a document management server 1201, a centralized print management server 1202, and a print server 1203, via an ordinary network.

However, the servers 1201 through 1203, if operable as clients, can be connected to the client document processing system 1200 using interprocess communication simulating the internetwork communication.

According to the example illustrated in FIG. 12, both the document management server 1201 and the centralized print management server 1202 are connected to the client. However, only one of the document management server 1201 and the centralized print management server 1202 may be connected to the network.

For example, if only the document management server 1201 is connected to the network, a document management server-client system 1201SC including the client module 108 of the document management server 1201 is added to the stand-alone type document management system.

Furthermore, if only the centralized print management server 1202 is connected to the network, a print management server-client system 1202SC including client modules of the centralized print management server 1202 is added to the stand-alone type document management system.

The document management server 1201 is a server capable of storing book files generated and edited by the bookbinding application 104. The document management server 1201 has a database 1211 that can store book files to be managed, although the book files can be also stored in a local HD of the client PC.

The book file storage and reading processing between the bookbinding application 104 and the document management server 1201 is performed via the DS client 108 and a DS core 1212.

The centralized print management server 1202 manages printing of book files stored in the client document processing system 1200 or in the document management server 1201.

A print request issued by the client is transmitted via the DOMS driver 109 and the DOMS print service module 110 to a document output management service workgroup (DOMS WG) server module 1221 of the centralized print management server 1202.

When printing is performed by the printer 107 of the client, the centralized print management server 1202 sends electronic original data to the electronic original despooler 105 via the DOMS print service module 110 of the client.

When printing is performed by the print server 1203, the centralized print management server 1202 transmits the electronic original data to a DOMS print service module 1231 of the print server 1203. For example, the centralized print management server 1202 performs a security check about the qualification of a user who has requested printing of a stored book file and stores a print processing log.

As described above, the document processing system can be arranged as a stand-alone system or a client server system.

As described above, when the bookbinding application 104 opens a book file, the user interface screen 1100 illustrated in FIG. 10 is displayed on the CRT 210.

A tree illustrated in the tree section 1101 represents a structure of the opened book (hereinafter, referred to as an “attentional book”).

The present exemplary embodiment prepares a total of three display methods for the preview section 1102, which can be selected according to, for example, a user's preference.

A first display method is referred to as an “original view mode” which directly displays reduced images of original pages belonging to the attentional book, although the display in the preview section 1102 does not reflect the layout.

A second display method is referred to as a “print view mode” which displays original page images in the preview section 1102 that reflects the layout of the original pages.

A third display method is referred to as a “simple print view mode” which does not display the contents of each original page in the preview section 1102 although the layout is reflected.

An example of staple control performed by the bookbinding application 104 of the computer 100, which is connected to a printer having a staple function, is described.

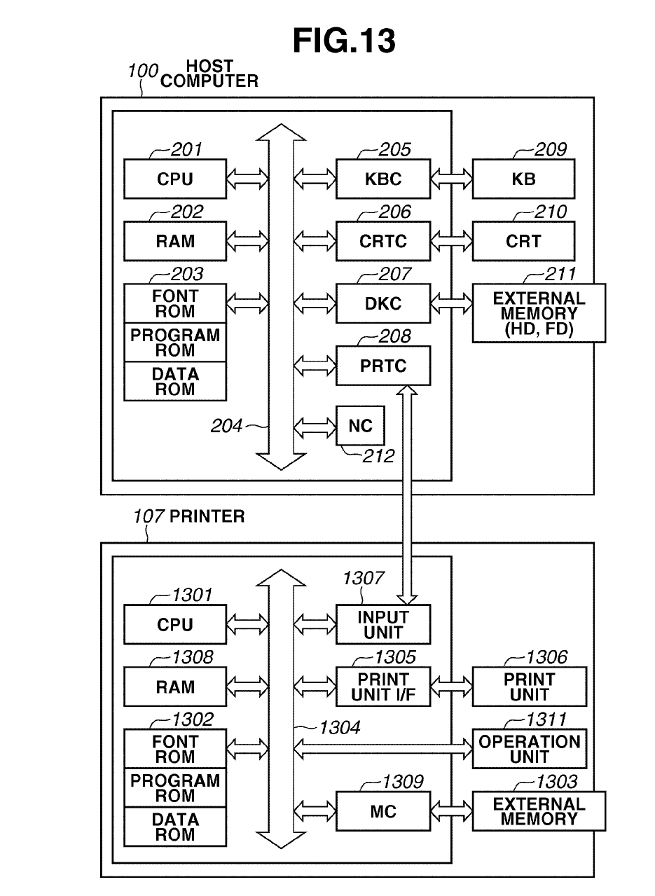

FIG. 13 is a block diagram illustrating an example document processing system according to the present exemplary embodiment. The document processing system illustrated in FIG. 13 is a staple control system, which includes the embodiment of the host computer 100 illustrated in FIG. 2 and the printer 107 having the staple function. In FIG. 13, components similar to those illustrated in FIG. 2 are denoted by the same reference numerals.

An example configuration of the printer 107 is described below. The present invention can be applied to a single device, a system including a plurality of devices, and a processing system connected via a network (e.g., local area network (LAN) or a wide area network (WAN)) if they can realize the functions of the present invention.

As illustrated in the embodiment of FIG. 13, the printer 107 includes a printer CPU (CPU) 1301, which can execute control programs loaded from a program ROM area of a ROM 1302 and an external memory 1303.

The printer 107 outputs an image signal, as output information, to a print unit (printer engine) 1306 via a print unit I/F 1305 connected via a system bus 1304 according to the control program.

The program ROM area of the ROM 1302 stores the control program of the CPU 1301. A font ROM area of the ROM 1302 stores font data to be used when the output information is generated.

A data ROM area of the ROM 1302 stores information to be used by the host computer 100 if the printer does not have the external memory 1303 (e.g., hard disk).

The CPU 1301 can communicate with the host computer 100 via an input unit 1307, for example, to notify the host computer 100 of information of the printer 107.

The printer 107 includes a RAM 1308, which can function as a main memory or a work area for the CPU 1301. The printer 107 has an expansion port (not illustrated) to which an optional RAM can be connected to increase the memory capacity.

The RAM 1308 can be used as an output information expansion area, an environmental data storage area, or a non-volatile random access memory (NVRAM). A memory controller (MC) 1309 controls every access to the above-described external memory 1303, such as a hard disk (HD) or an IC card.

The external memory 1303 is connectable as an optional device and usable as a storage device for font data, emulation programs, and form data.

An operation unit 1311 includes various operation switches and a light-emitting diode (LED) display device.

The above-described external memory 1303 is not limited to a single memory unit and can be a plurality of memory units which, for example, store programs capable of interpreting the language of an optional card or the control language of a different printer in addition to built-in fonts.

The external memory 1303 can include an NVRAM (not illustrated), which stores printer mode setting information entered via the operation unit 1311.

The bookbinding application 104 can set a variable field, as a page attribute of a generated book file, to execute variable printing. An example of variable printing is described below.

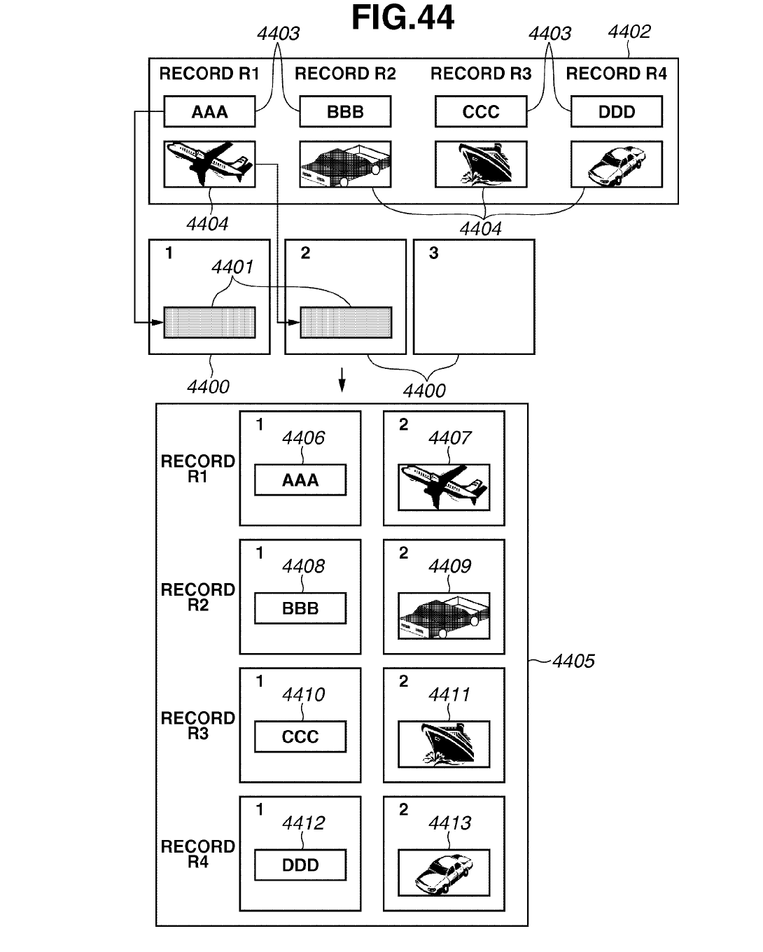

FIG. 44 illustrates page layout examples to be used in the variable printing performed by the document processing system according to the present exemplary embodiment.

In FIG. 44, an original page 4400 includes a variable field 4401, in which the variable printing can be executed. The number of variable fields 4401 is not limited to a specific number. A plurality of variable fields can be disposed on one original page 4400. To realize a customized printing, the document processing system inserts preselected data, which can be selected from a database 4402, in the variable field.

The database 4402 manages various data, which can be inserted in the variable field 4401.

The database 4402 includes a plurality of identifiers, which can be referred to as “records”, each designating a unit of data to be added to the original page.

According to the example illustrated in FIG. 44, the database 4402 manages four records R1 to R4. Each record in the database 4402 includes text data 4403 and image data 4404.

According to the example illustrated in FIG. 44, the first page of the original pages includes the variable field 4401 in which the text data 4403 is inserted and the second page of the original pages includes the variable field 4401 in which the image data 4404 is inserted. Examples of setting of variable fields and setting of relevancy to the database data are described below in more detail.

An actual example of original pages 4405 can include various text and image data inserted from the database 4402. As a result of insertion of the record R1, text data “AAA” 4406 of the record R1 is disposed on the first page of the original pages.

Image data of the record R1 (an airplane image 4407) is disposed on the second page of the original pages. If the record R2 is inserted, text data “BBB” 4408 of the record R2 is disposed on the first page of the original pages and image data of the record R2 (a truck image 4409) is disposed on the second page of the original pages. Similarly, data 4410 to 4413 of the records R3 and R4 can be disposed on the first and second pages of the original pages.

As no variable field is set on the third page of the original pages, the third page cannot include any data to be inserted from the database 4402. However, regardless of insertion of data, printing of the third page of the original pages can be performed for all records. In this manner, the variable printing can realize many patterns, the number of which is equal to the number of original pages×the number of records.

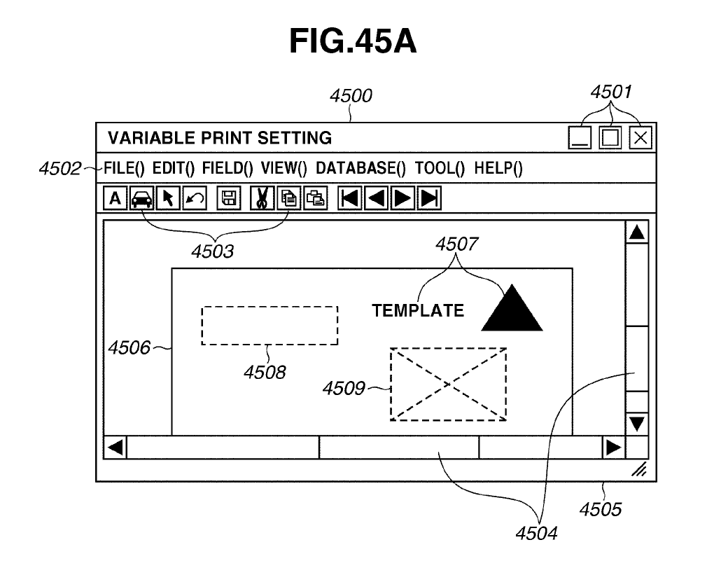

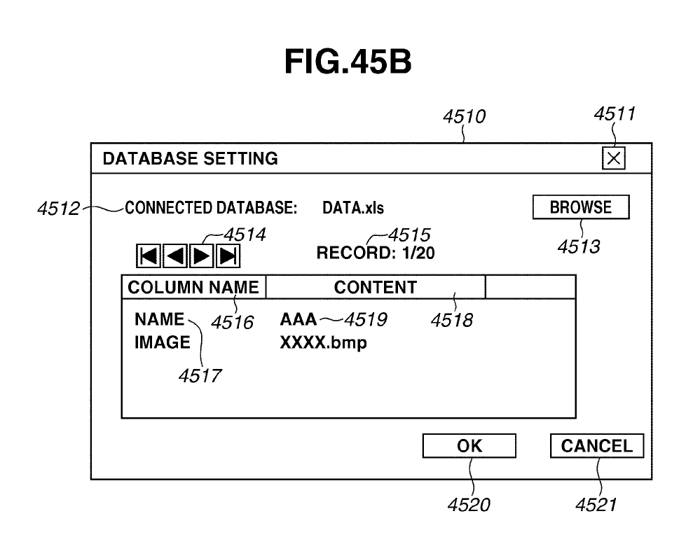

FIGS. 45A and 45B illustrate example user interfaces, which can be displayed on the embodiment of the CRT 210 illustrated in FIG. 2.

FIG. 45A illustrates an example UI of a variable print editor, which enables users to perform settings for the above-described variable printing. The variable print editor, which can be activated by the bookbinding application 104, enables users to perform print settings for each logical page of a book file.

When the variable print editor is activated, a UI screen 4500 can be displayed as illustrated in FIG. 45A. Buttons 4501 enable users to minimize, maximize, and close the window of the variable print editor. A menu bar 4502 enables users to instruct various editing operations of the variable print editor. Tool buttons 4503 enable users to perform predetermined operations for the variable printing.

Scroll bars 4504 enable users to scroll on the entire original page to be edited in the window, if the variable print editor cannot display at least part of the original page.

A glove control 4505 of the variable print editor enables users to arbitrarily change the window size using the mouse pointer.

The UI screen 4500 includes a display field for an original page 4506 to be edited by the variable print editor.

The original page 4506 includes some objects 4507 drawn thereon. As described above, the function of the variable print editor is limited to setting of the variable field. Therefore, the variable print editor cannot edit the objects 4507 on the original page because the objects 4507 exist outside the variable field.

A variable text field 4508 is a field where text data can be inserted. A variable image field 4509 is a field where image data can be inserted.

In the present exemplary embodiment, the variable text field and the variable image field can be collectively referred to as “variable fields.”

To generate these fields, users can operate the menu 4502 and the tool button 4503 to select a variable field generation function and can operate the mouse cursor to draw a rectangular frame defining a field (a synchronization field or an ordinary field).

FIG. 45B illustrates an example UI indicating a method for accessing a database to set data to be inserted in the variable field.

The example UI illustrated in FIG. 45B includes a connection dialog 4510. A close button 4511 enables users to close the connection dialog 4510. The connection dialog 4510 can be displayed when the menu 4502 or the tool button 4503 is operated.

The connection dialog 4510 includes an area 4512 to be used to set a database. If there is any database already connected, the area 4512 displays the name of each database file being currently connected. If no database is connected, the area 4512 is blank. A user can press a browse button 4513 to display a database file browsing dialog, which enables the user to designate a database file.

If the user selects another database file using the browse button 4513, connection is switched from the currently connected database to the newly selected database.

Various controls 4514 to 4519 are enabled when the database is connected to indicate the content of the currently connected database.

A record shift button 4514 can be used to shift a record in the currently connected database. A record number 4515 indicates the total number of records stored in the database and displays the present content.

A “column name” field 4516 indicates the type of an attribute of each record data in the currently connected database. The database illustrated in FIG. 45B has two attributes “name” and “image” 4517.

A “content” field 4518 indicates a value (data) corresponding to the column name of each record stored in the currently connected database. According to the example illustrated in FIG. 45B, the “content” field 4518 displays a value “AAA” corresponding to the “name” attribute and a value “XXXX.bmp” corresponding to the “image” attribute.

If a user shifts the record using the record shift button 4514, the content of data 4519 can be shifted according to a number of the changed record. A user can fix (finalize) the contents having been set using the connection dialog 4510 by pressing an OK button 4520.

The user can press a cancel button 4521 to close the connection dialog 4510 without reflecting any setting contents.

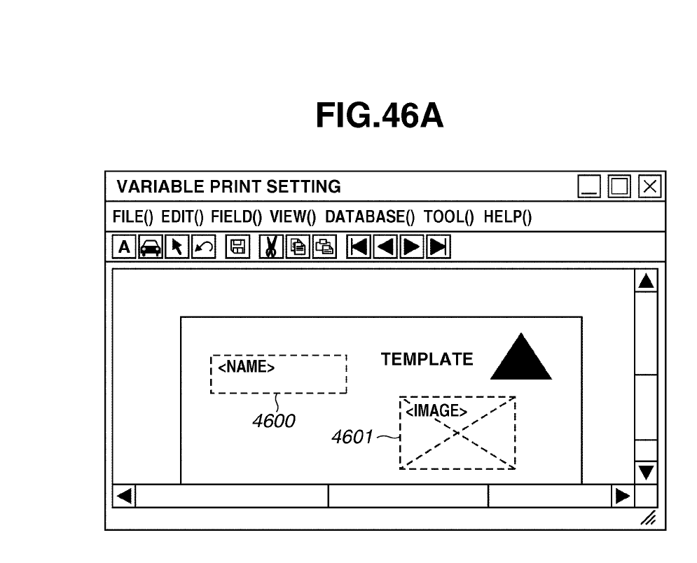

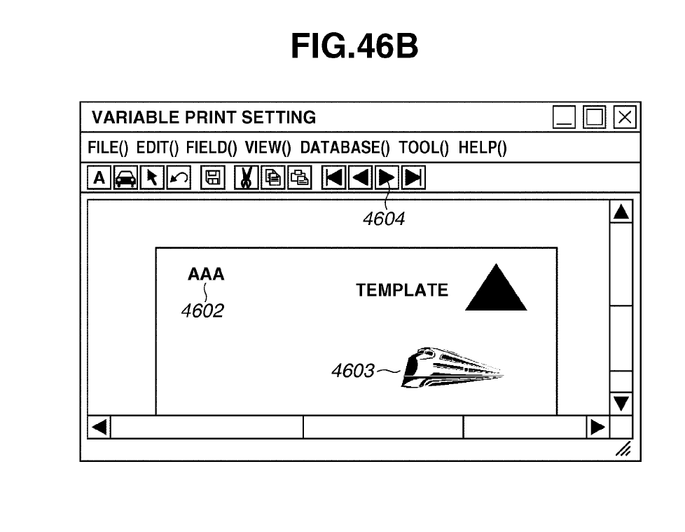

FIGS. 46A and 46B illustrate example user interfaces to be displayed on the CRT 210 illustrated in FIG. 2.

In FIG. 46A, the above-described “name” column is set in a variable text field 4600.

As a setting method, any column of the connected database can be set as a property of the variable text field 4600.

A plurality of columns of the database can be set in the variable text field 4600.

The above-described “image” column is set in a variable image field 4601. As a setting method, any column of the connected database can be set as a property of the variable image field 4601. A plurality of columns of the database can be set in the variable image field 4601.

FIG. 46B illustrates an example UI including a preview of the setting contents, which enables users to confirm a setting state of the database data inserted in the variable fields.

In FIG. 46B, a field 4602 displays “AAA” as the value of the “name” column inserted in the variable text field 4600 illustrated in FIG. 46A.

A field 4603 displays an “image of a tramcar” as the value of the “image” column inserted in the variable image field 4601 illustrated in FIG. 46A.

Record shift buttons 4604 enable users to shift a record of the database to preview the data of each record.

In the present exemplary embodiment, the bookbinding application 104 displays a print dialog to allow users to designate ON/OFF of the variable printing. Accordingly, if the variable printing is not designated by a user using the print dialog, the bookbinding application 104 executes printing without reflecting the contents set by the variable print editor.

In one version, the bookbinding application 104 includes an original editor enabling users to edit texts/images of a generated book file.

The original editor, which can be activated by the bookbinding application 104, can edit each logical page of the book file.

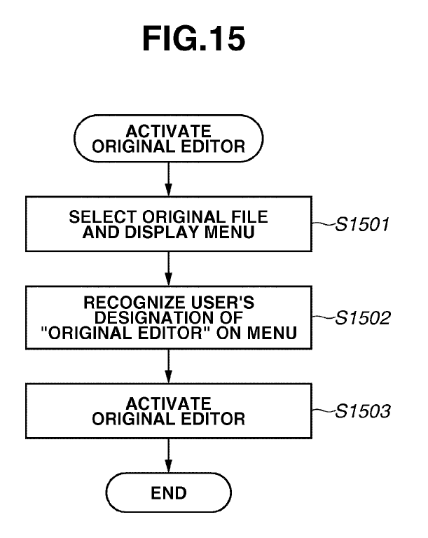

FIG. 15 is a flowchart illustrating an example procedure of data processing, which can be performed by the document processing apparatus, according to the present exemplary embodiment. The processing illustrated in FIG. 15 may be performed by the bookbinding application 104 to activate the original editor for a selected original file.

In step S1501, the bookbinding application 104 causes the CRT 210 to display a menu for the selected original file.

In step S1502, the bookbinding application 104 recognizes a user's designation of the “original editor” on the menu displayed in step S1501. In step S1503, the bookbinding application 104 activates the original editor, which displays a main screen on the CRT 210. Then, the bookbinding application 104 terminates the processing routine illustrated in FIG. 15.

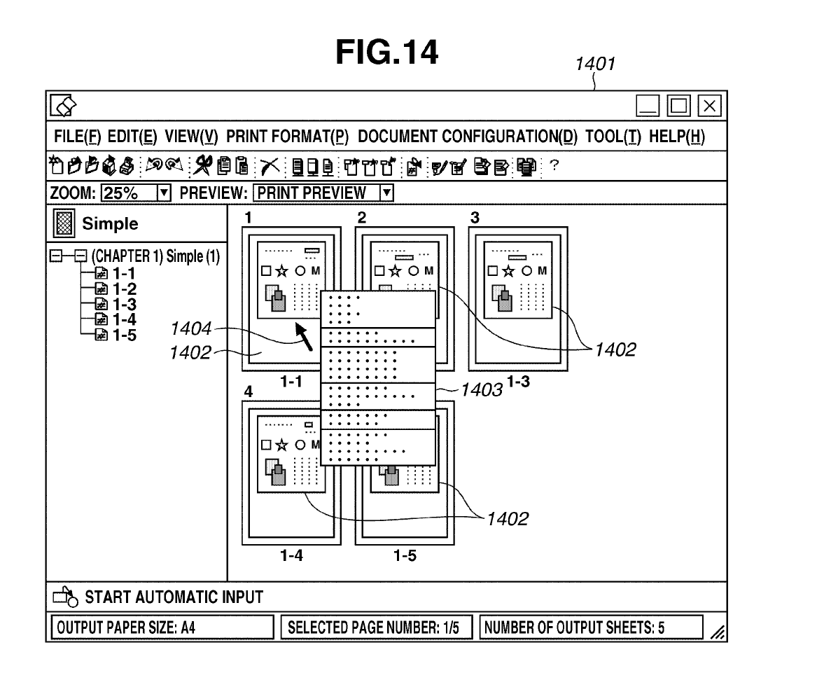

FIG. 14 illustrates an example user interface, which can be displayed on the embodiment of the CRT 210 illustrated in FIG. 2. The bookbinding application 104 may enable users to activate the original editor using the user interface illustrated in FIG. 14.

An example of a bookbinding application UI 1401 illustrated in FIG. 14 includes a display field where imported original files 1402 can be displayed.

A pop-up menu 1403 appears upon selection of an original file. To activate the original editor, a user can select an imported original file with a mouse pointer 1404 and, when the pop-up menu 1403 is displayed, can designate the “original editor” in the menu.

In one version, the original editor may have the following editing function.

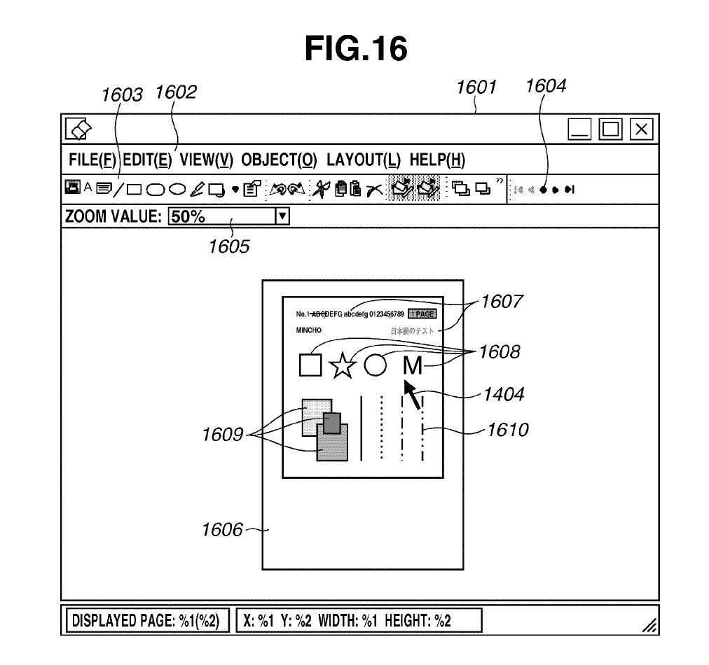

FIG. 16 illustrates an example user interface, which can be displayed on the embodiment of the CRT 210 illustrated in FIG. 2. The user interface illustrated in FIG. 16 may be an overall UI for the original editor.

An original editor UI 1601 includes a menu bar 1602, tool buttons 1603, page shift buttons 1604, and a zoom designation box 1605.

An original file 1606 (an object to be edited) includes text objects 1607, graphic objects 1608 and 1609, and line objects 1610.

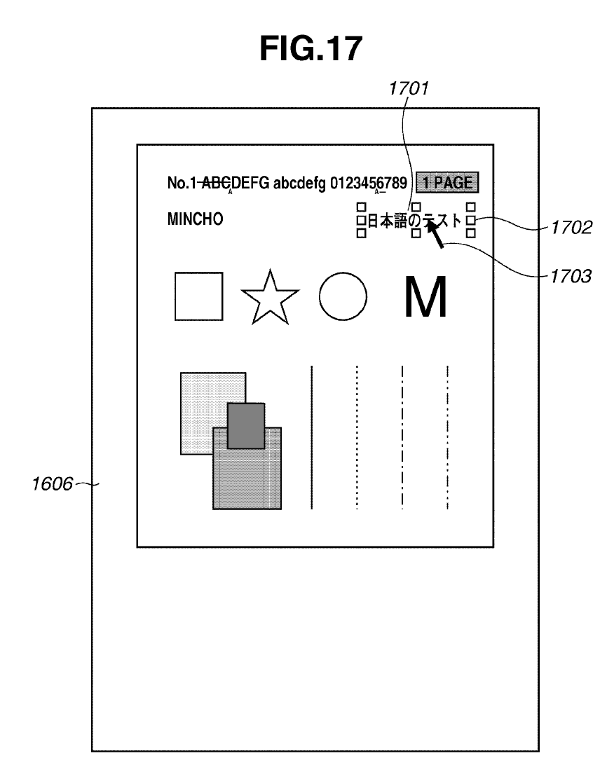

FIG. 17 illustrates an example user interface, which can be displayed on the embodiment of the CRT 210 illustrated in FIG. 2. The user interface illustrated in FIG. 17 may enable users to select a text object.

In FIG. 17, object control handles 1702 are displayed around a text object 1701 together with a mouse pointer 1703.

More specifically, when a user selects a text on the original file with the mouse pointer 1703, the control handles 1702 appear around the selected text to indicate a selection state.

In one version, the text object can be selectively moved and deleted. An attribute of the text object can also be changed. A text can also be added to or deleted from the text object.

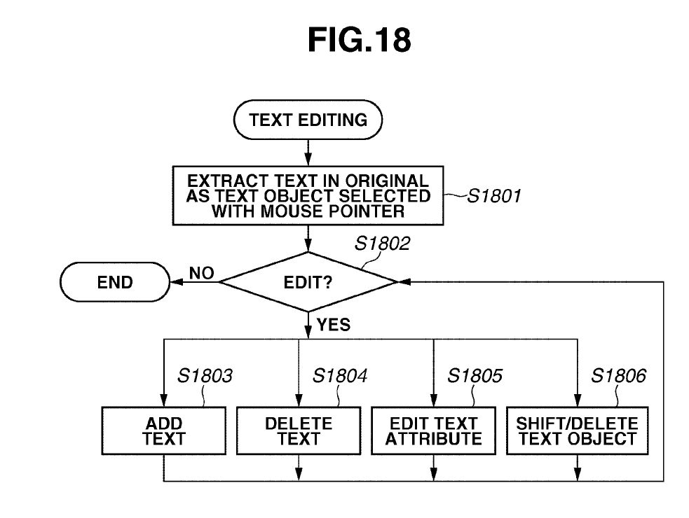

FIG. 18 is a flowchart illustrating an example procedure of data processing, which can be performed by the document processing apparatus, according to the present exemplary embodiment. FIG. 18 illustrates example text editing processing performed by the original editor.

In step S1801, the original editor extracts a text in the original file, for example as a text object selected with the mouse pointer 1703 based on a user's mouse operation.

In step S1802, the original editor determines an editing content requested for the extracted text object. If no editing content is requested (NO in step S1802), then the text editing process is ended. If editing content is selected (YES in step S1802), processing proceeds to one or more of steps S1803 to S1806. In steps S1803 to S1806, the original editor executes various editing processing (e.g., addition of text, deletion of text, change of text attribute, and shift/deletion of text object) on the extracted text object.

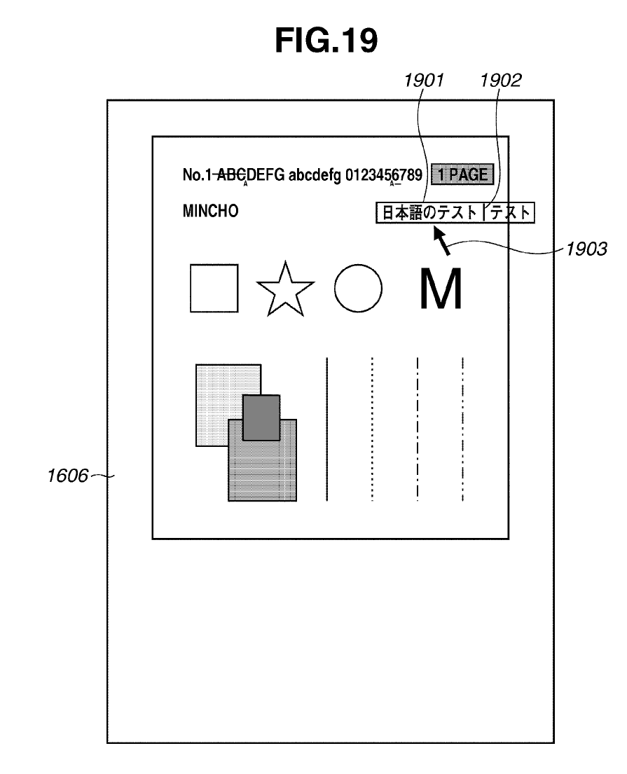

FIGS. 19 to 21 illustrate example user interfaces, which can be displayed on the embodiment of the CRT 210 illustrated in FIG. 2. FIG. 19 illustrates an example of editing performed by the original editor to add a text.

An example of editing for adding a text to the text object 1701 illustrated in FIG. 17 is described below with reference to FIG. 19.

In FIG. 19, if a user selects a text object in a selection state again with the mouse pointer 1903, a rectangular frame 1901 appears around the selected text object together with an editing cursor 1902. If the user moves the editing cursor 1902 to an intended position and inputs a character (or a character string), the input character (or character string) can be added to the text object.

The example illustrated in FIG. 19 includes a word “ [symbol] (TEST)” newly inserted immediately before the final part “ [symbol] (TEST)” of the original character string “ [symbol] (TEST OF JAPANESE WORDS)”.

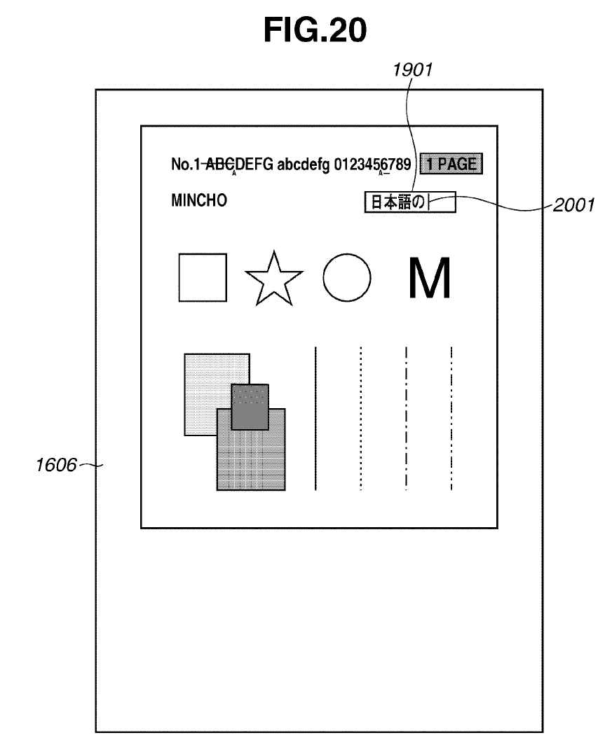

FIG. 20 illustrates an example of deletion of a text, which can be performed by the original editor.

The example of text deletion processing performed on the text object 1701 illustrated in FIG. 17 is described below with reference to FIG. 20. Similar to the above-described text addition processing, the rectangular frame 1901 appears around the selected text object together with an editing cursor 2001. If a user moves the editing cursor 2001 in an active state using a back space key or a deletion key, at least part of the text object can be deleted.

The editing processing according to the present exemplary embodiment can include editing of any text attribute in each text object. The text attributes may include one or more of font, style size, color, character decoration, character spacing, horizontal scaling rate, and word spacing, although their meanings and setting methods are not described below.

The above-described text object editing is limited to only one line. However, the original editor can newly generate a plurality of text lines and a text box can be used if the generated text includes two or more text lines.

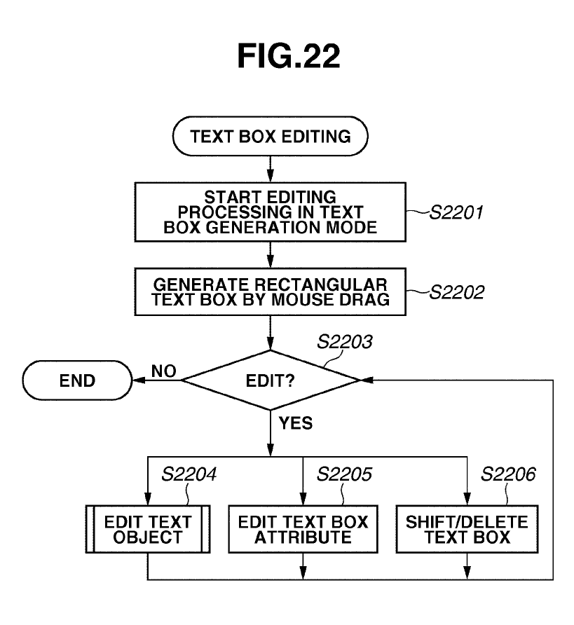

FIG. 22 is a flowchart illustrating an example procedure of data processing, which can be performed by the document processing apparatus, according to the present exemplary embodiment. FIG. 22 illustrates an example of text box editing processing.

In step S2201, the original editor starts editing processing in a text box generation mode. In step S2202, the original editor generates a text box.

In step S2203, the original editor determines whether the editing processing has been completed. More specifically, the original editor determines the content of an editing request. If editing content is requested (YES in step S2203), then Processing proceeds to one or more of S2204-S2206. For example, in step S2204, the original editor performs editing of the text object (which is similar to the above-described editing processing applied to a one-line text). Then, the processing returns to step S2203.

Similarly, in step S2205, the original editor performs editing of a text box attribute according to the editing content determination result in step S2203. Then, the processing returns to step S2203.

Similarly, in step S2206, the original editor performs shifting/deletion of the text box based on the editing content determination result in step S2203. Then, the processing returns to step S2203.

If in step S2203 the original editor determines that the editing processing has been completed (NO in step S2203), the original editor terminates the processing routine illustrated in FIG. 22.

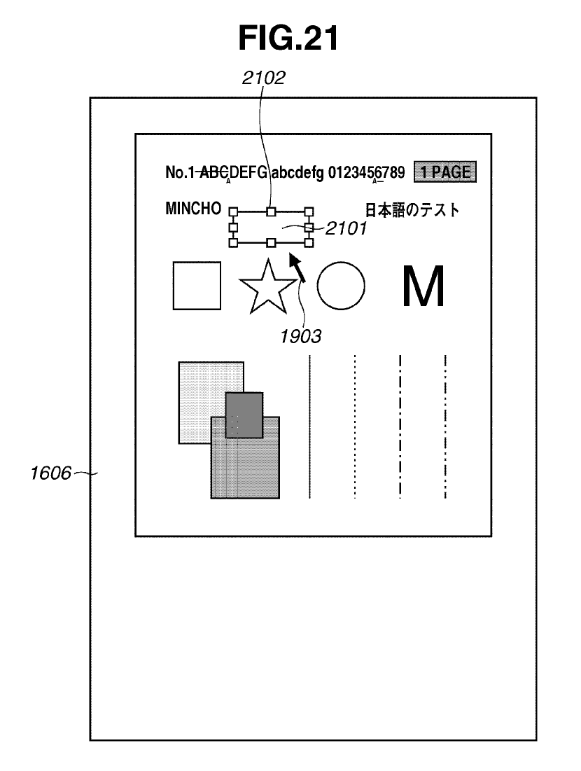

FIG. 21 illustrates an example text box generation on an example UI screen.

In the example shown in FIG. 21, a text box 2101 is a rectangular field (frame), which can be drawn by a user with the mouse pointer 1903 on the original file 1606 in the text box generation mode. When the text box 2101 is generated, a total of eight control handles 2102 are displayed to define respective corners and midpoints of respective sides. The text box 2101 can be resized when a user drags one of the control handles 2102 with the mouse pointer 1903.

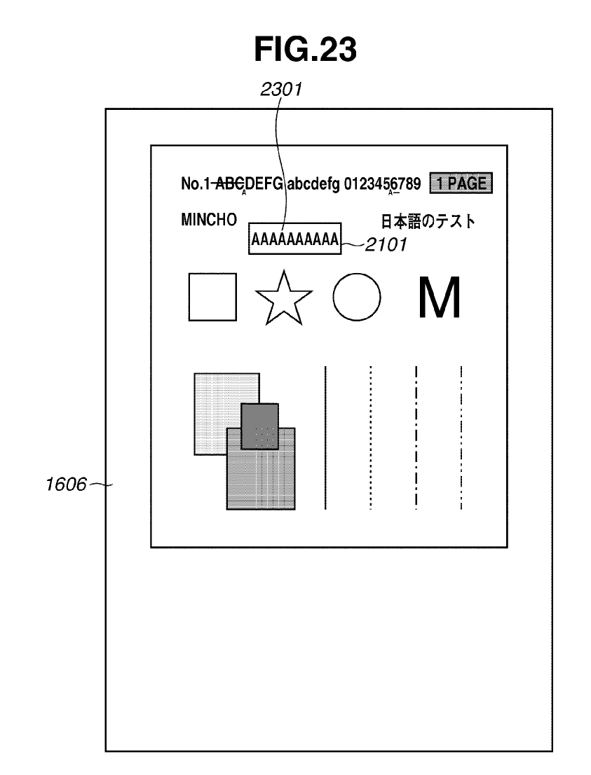

FIG. 23 illustrates an example user interface, which can be displayed on the embodiment of the CRT 210 illustrated in FIG. 2. According to the example illustrated in FIG. 23, a text 2301 “AAAAAAAAAA” is added to the text box 2101.

Similar to the text object editing, if a user selects the text box 2101 in the selection state with the mouse pointer 1903 again, an editing cursor appears in the text box 2101.

In this state, the user can add a text in the text box 2101 and can delete at least part of the text in the text box 2101.

Similar to the text object, the user can edit an attribute of the text box and an attribute of a text in the text box.

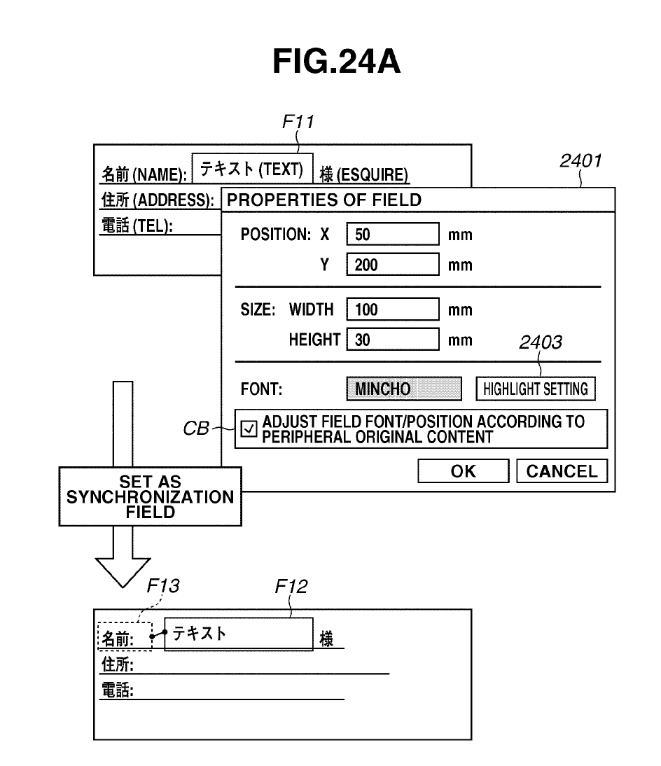

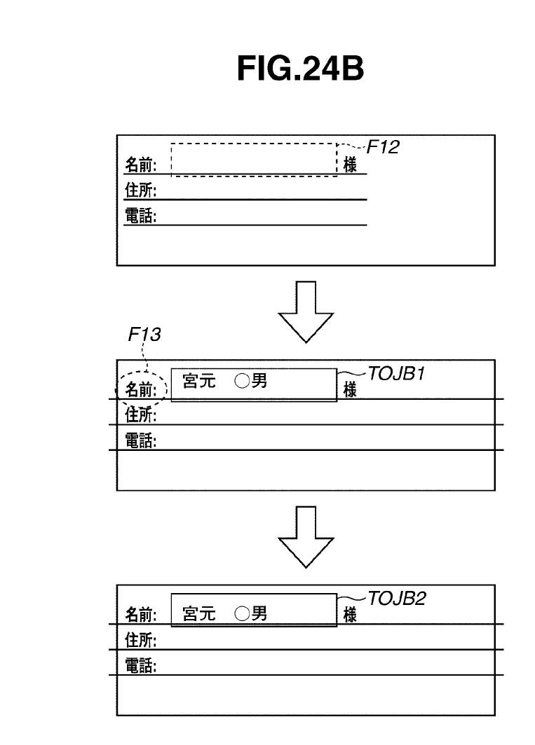

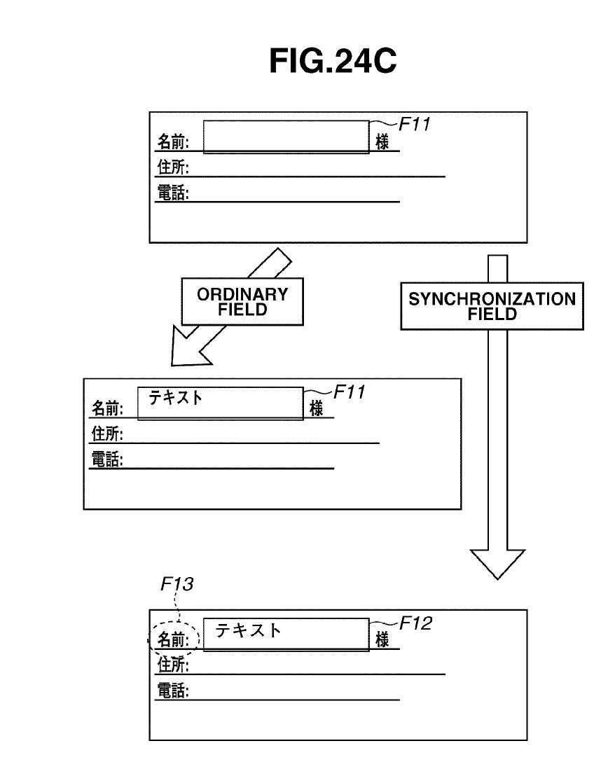

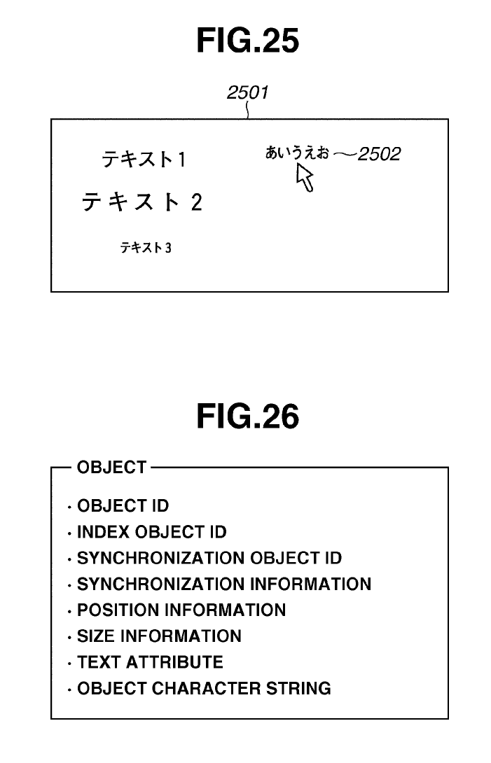

FIG. 24A illustrates an example user interface, which can be displayed on the embodiment of the CRT 210 illustrated in FIG. 2. The example user interface illustrated in FIG. 24A enables users to generate a synchronization field, according to which a selected text object has a text attribute that is identical to that of a peripheral text object. An example display of the UI screen illustrated in FIG. 24A is described below with reference to FIGS. 24A to 24C and FIG. 25.

FIGS. 24B and 24C illustrate examples of document editing processing, which can be performed by the document processing apparatus, according to the present exemplary embodiment.

If a user checks a check box CB on a property screen of a target field F11 illustrated in FIG. 24A, the bookbinding application 104 sets the target field F11 as a synchronization field F12 as illustrated in FIG. 24B.

Then, if an index object F13 is retrieved by the index object retrieval processing as described below, the bookbinding application 104 executes synchronization processing for reflecting an attribute of the index object F13 in an object TOJB1 in the synchronization field F12.

Thus, the object TOJB1 in the synchronization field F12 can be adjusted in both font attribute and field position according to the index object F13 and displayed as an object TOJB2.

If the user does not check the check box CB on the property screen illustrated in FIG. 24A, an ordinary field similar to the target field F11 is generated as illustrated in FIG. 24C.

FIG. 25 illustrates an example logical page including a text object, which can be processed by the information processing apparatus, according to the present exemplary embodiment.

In FIG. 25, in a state where a logical page 2501 is activated by the original editor, a pop-up menu appears if a user selects a text object 2502 using the right click. In this state, a setting screen 2401 such as that illustrated in FIG. 24A can be displayed if the user selects a setting change item on the menu.

In FIG. 24A, by checking the check box CB, the field F11, which is designated by the property of the object, can be generated as the above-described synchronization field F12. The object in the generated synchronization field is referred to as the synchronization object. The index object F13 to be retrieved for the synchronization field F12 can be displayed differently from the synchronization field F12, for example, in color and shape on an editing screen.

For example, by checking the check box CB illustrated in FIG. 24A, the field of the text object 2502 can be changed from the ordinary field to the synchronization field in the logical page 2501 illustrated in FIG. 25. The synchronization object can be flexibly generated.

A text attribute of the text object having been set as the synchronization object can be equalized with a text attribute of the index object (i.e., a target object).

A highlight setting addition button 2403 enable users to apply a highlight setting to the synchronization object, to differentiate the text attribute of the synchronization object from the text attribute of the index object.

A font size for the synchronization object can be set to be larger, e.g., by two points, than that of the index object. The italic font style can be set for the synchronization object if the index object has another font style.

A synchronization setting unit is also present as a property of the variable text field. The variable text field can be set as a synchronization object.

FIG. 26 illustrates an example data structure of a text object, which can be processed by the information processing apparatus, according to the present exemplary embodiment.

In FIG. 26, “object ID” stores a value that can identify each object. For example, serial numbers starting from the upper right can be allocated to all objects on a logical page.

“Index object ID” stores an object ID of an index object (i.e., a target in setting of the text object) if the present object is a synchronization object.

When no value is stored in the index object ID, the present object is an ordinary text object.

“Synchronization object ID” stores an object ID of any other text object that designates the present text object as an index object. If there are two or more other text objects that designate the present text object as an index object, the synchronization object ID stores all object IDs of the plurality of other text objects.

“Synchronization information” stores additional setting when the present object is a synchronization object.

For example, information relating to highlight setting (e.g., font size enlarged by two points compared to that of the index object) is the synchronization information.

“Position information” stores information indicating the position of the text object on the logical page. For example, coordinate values representing the position of the text object in the horizontal and vertical directions on the page can be stored as the position information. “Size information” stores the size of a drawing area of the text in the horizontal and vertical directions.

The data structure of the text object further includes “Text attribute” and “Object character string” and can include addition items.

For example, when the variable field is a synchronization object, a character string can be acquired from a database. Therefore, the object has no character string information. Instead, information relating to the connected database can be added as an additional item.

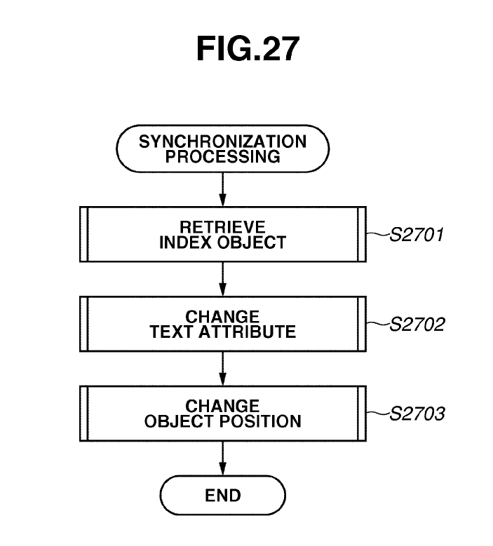

FIG. 27 is a flowchart illustrating an example procedure of data processing, which can be performed by the document processing apparatus, according to the present exemplary embodiment. FIG. 27 illustrates example processing for changing an ordinary text object to a synchronization object.

First, retrieval processing is performed on all text objects of a selected logical page to detect an object closest to an object having been set as a synchronization object.

Then, the retrieved object is set as an index object. Text attributes and position information acquired from the index object are reflected in the synchronization object. Processing in each step of the example of FIG. 27 is described below.

In step S2701, the bookbinding application 104 retrieves an index object, as described below in more detail with reference to a flowchart illustrated in FIG. 8.

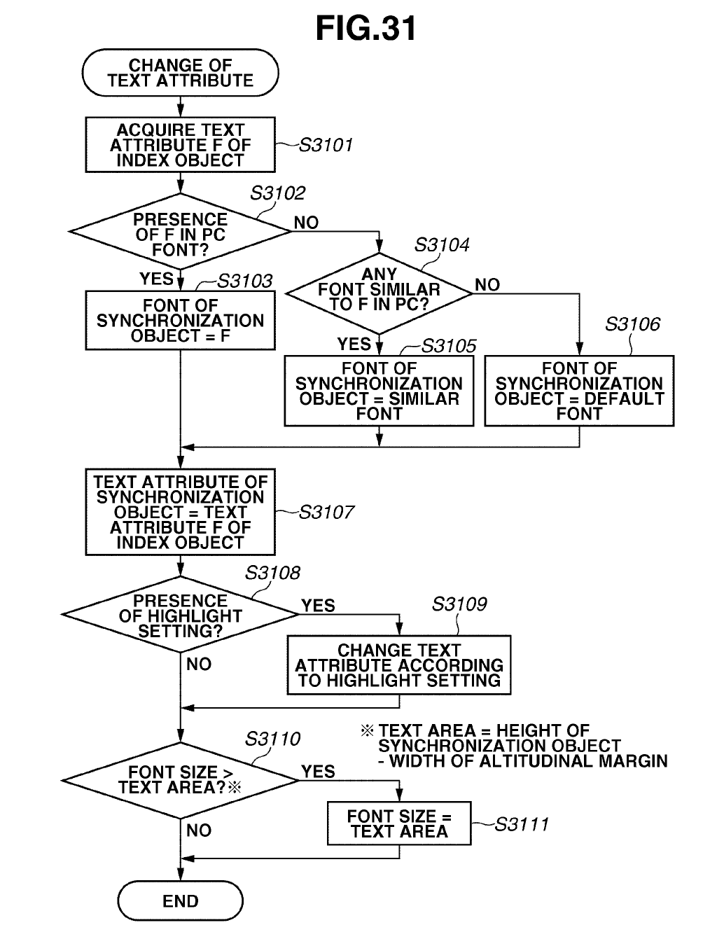

In step S2702, the bookbinding application 104 changes text attributes of the synchronization object so as to accord with the text attributes of the index object, as described below in more detail with reference to FIG. 31.

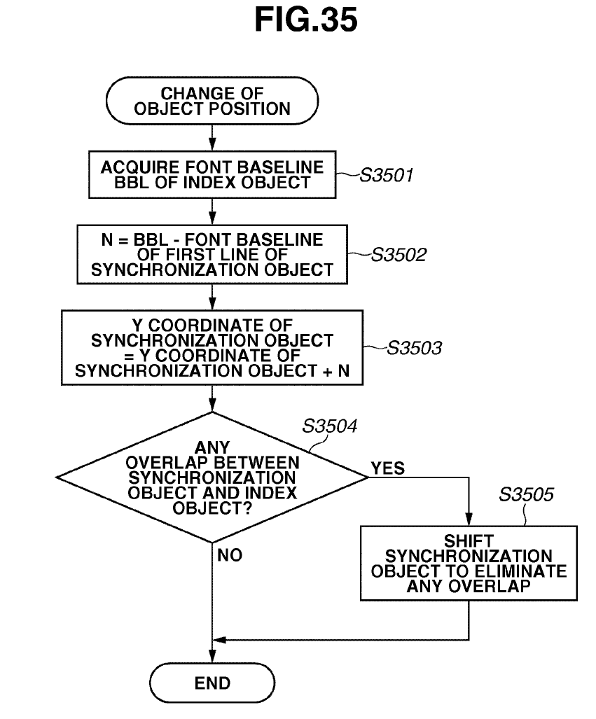

In step S2703, the bookbinding application 104 changes the layout position of the synchronization object, as described below in more detail with reference to FIG. 35. Then, the bookbinding application 104 terminates the processing routine illustrated in FIG. 27.

Examples of synchronization processing for setting a field of an ordinary text object as a synchronization field through the above-described procedures are described below.

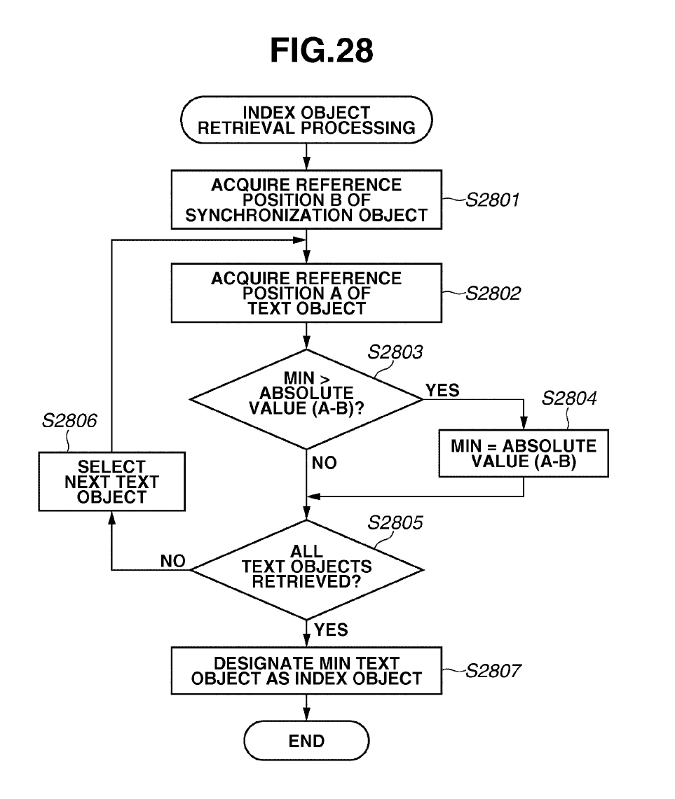

FIG. 28 is a flowchart illustrating an example procedure of data processing, which can be performed by the document processing apparatus, according to the present exemplary embodiment. FIG. 28 illustrates details of the processing performed in step S2701 of FIG. 27.

The present processing includes calculating the distances of the synchronization object and each text object relative to a reference position, for all text objects on a selected logical page. The bookbinding application 104 sets an object having a smallest calculated value as an index object of the synchronization object. Processing in each step of FIG. 28 is described below.

In step S2801, the bookbinding application 104 acquires a reference position B of the synchronization object. In step S2802, the bookbinding application 104 acquires a reference position A of a text object on the logical page.

In this case, the reference position can be set to an arbitrary position, which may compare the distance of the text object and the distance of the index object.

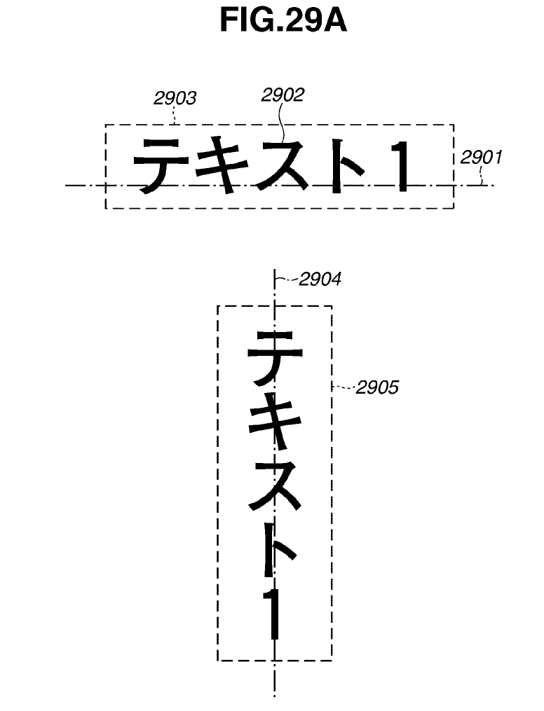

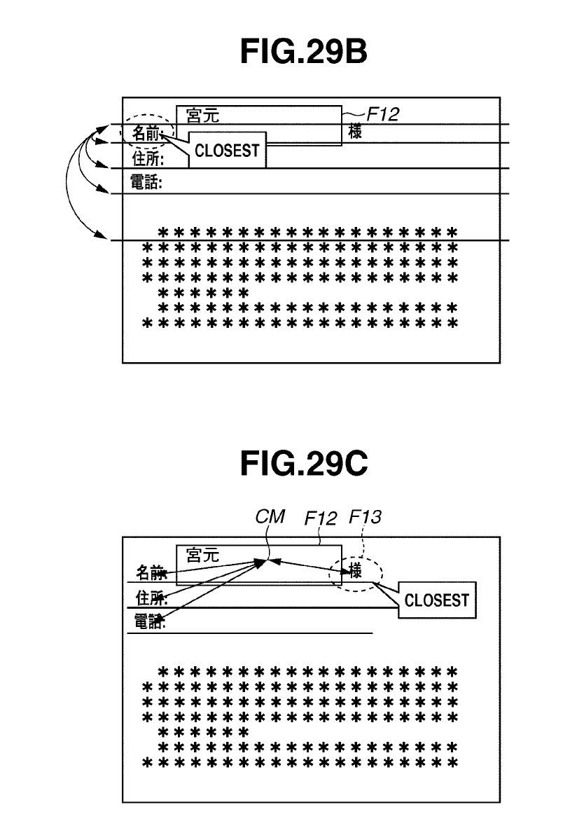

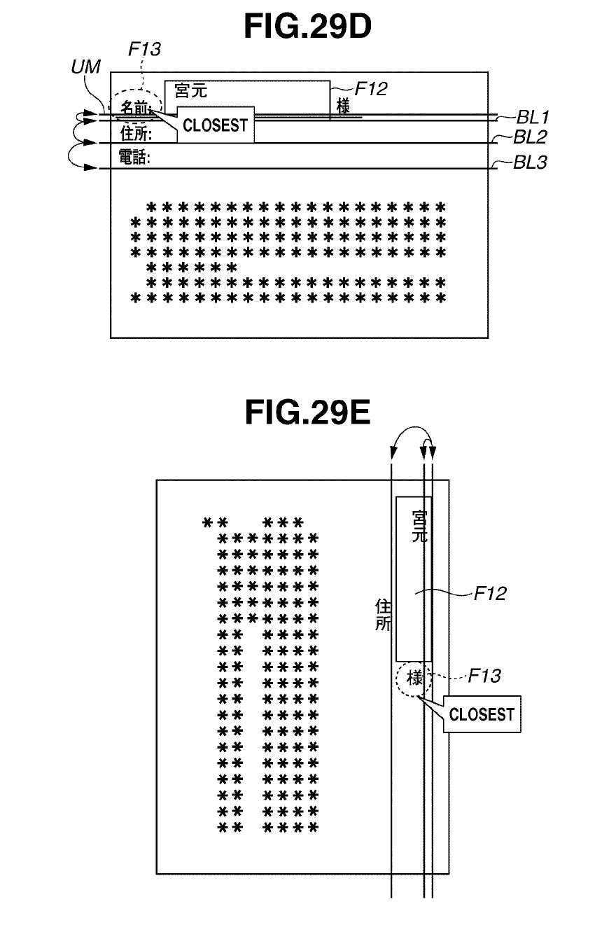

FIG. 29A illustrates an example reference position of a text object to be processed by the information processing apparatus of the present exemplary embodiment. An example position, which can be used as a reference position, is described below with reference to FIG. 29A.

In FIG. 29A, a vertical coordinate value representing the position of a font baseline 2901 can be used as a reference position for a horizontal writing font illustrated at the upper part thereof. Similarly, a central coordinate 2902 or an upper-side coordinate 2903 of the text object (rectangular area) can be used as the reference position for the horizontal writing font.

A horizontal coordinate value representing the position of a centerline 2904 can be used as a reference position when the synchronization object is a vertical writing font illustrated at the lower part of FIG. 29A. Similarly, a right-side coordinate 2905 of the text object can be used as the reference position for the vertical writing font. The reference position for the synchronization object can be differentiated from the reference position for another text objects.

Example index object retrieval processing is described below with reference to FIGS. 29B to 29E.

FIGS. 29B and 29E illustrate index object retrieval processing using the font baseline as the reference position, according to which the index object F13 is a text object closest to the font baseline of the synchronization field F12.

FIG. 29C illustrates index object retrieval processing using the distance between a central coordinate CM of the synchronization field and the central coordinate of each object as a reference position.

FIG. 29D illustrates index object retrieval processing using the distances between a downside coordinate UM of the synchronization field and baselines BL1 to BL3 of respective objects as reference positions. The index object F13 is a text object corresponding to the baseline BL1, which is closest to the downside coordinate UM.

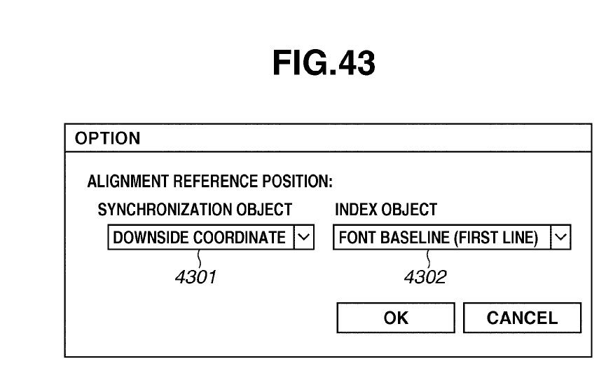

FIG. 43 illustrates an example user interface, which can be displayed on the embodiment of the CRT 210 illustrated in FIG. 2.

In FIG. 43, a synchronization object reference position setting unit 4301 enables users to set a reference position of the synchronization object. An index object reference position setting unit 4302 enables users to set a reference position of the index object.

According to the example illustrated in FIG. 43, “downside coordinate” is set as the reference position of the synchronization object and “font baseline (first line)” is set as the reference position of the index object. The settings of FIG. 43 can be used to determine reference positions for adjusting the object position.

In step S2803, the bookbinding application 104 obtains an absolute value between the reference position A of the text object and the reference position B of the synchronization object. Then, the bookbinding application 104 compares the obtained value with a value of MIN. In this case, the value of MIN is greater than the size of the logical page. Any value can be used if it does not finally become MIN when it is initially set as a large value.

If the bookbinding application 104 determines that the absolute value between the reference position A of the text object and the reference position B of the synchronization object is smaller than the value of MIN (YES in step S2803), the processing proceeds to step S2804. In step S2804, the bookbinding application 104 stores the absolute value between the reference position A of the text object and the reference position B of the synchronization object as an updated value of MIN. If the bookbinding application determines that the absolute value between the reference position A of the text object and the reference position B of the synchronization object is not smaller than the value of MIN (NO in step S2803), processing proceeds to step S2805.

In this case, the bookbinding application 104 stores an object ID of the text object that has derived the updated value of MIN.

In steps S2803 and S2804 of FIG. 28, “A” and “B” stand for the reference position A of the text object and the reference position B of the synchronization object.

In step S2805, the bookbinding application 104 determines whether the processing of steps S2802 to S2804 has been completed for all text objects on the logical page.

If the bookbinding application 104 determines that the processing of steps S2802 to S2804 has not been completed for all text objects on the logical page (NO in step S2805), the processing proceeds to step S2806. In step S2806, the bookbinding application 104 selects the next text object. Then, the bookbinding application 104 returns processing to step S2802, and may repeat the above-described processing of steps S2802 to S2804 to retrieve an index object for each text object on the logical page. If the bookbinding application 1-4 determines that the processing of steps 2802 to 2804 has been completed for all text objects on the logical page (YES in step S2805), processing proceeds to step S2807.

The text objects in step S2805 are all horizontally-written text objects if the synchronization object is expressed by the horizontal writing and all vertically-written text objects if the synchronization object is expressed by the vertical writing. Through the above-described processing, the bookbinding application 104 can identify a text object having finalized the value of MIN.

Then, the bookbinding application 104 stores the object ID of the text object having finalized the value of MIN as an index object ID of the synchronization object. Further, the bookbinding application 104 stores the object ID of the synchronization object as a synchronization object ID of the text object having finalized the value of MIN.

In step S2807, the bookbinding application 104 designates, as an index object, the text object having finalized the value of MIN through the above-described processing of steps S2801 to S2806. Then, the bookbinding application 104 terminates the processing routine illustrated in FIG. 28.

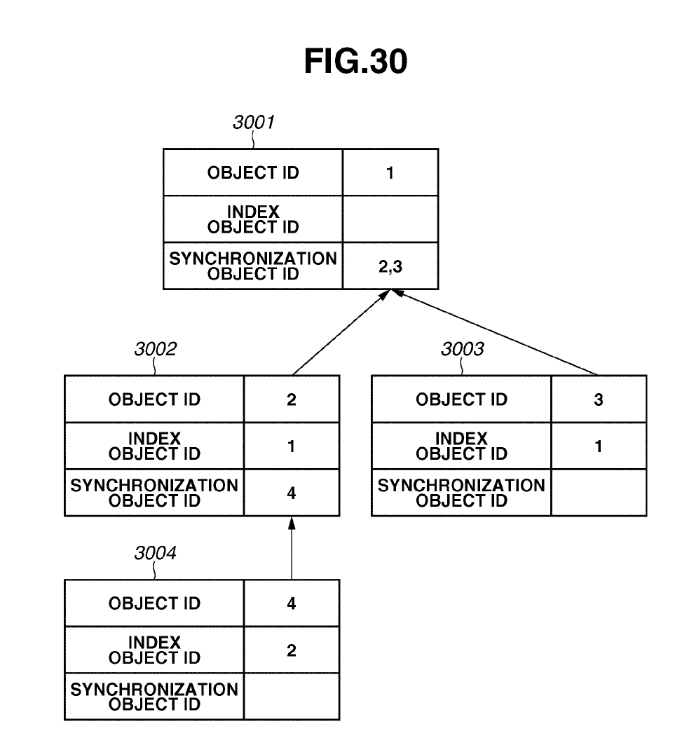

FIG. 30 illustrates an example relationship in data structure between the index object and the synchronization object, which can be processed by the information processing apparatus, according to the present exemplary embodiment.

In FIG. 30, a text object 3001 is designated as the index object of a synchronization object 3002 and a synchronization object 3003. The synchronization object 3002 is designated as the index object of a synchronization object 3004.

The text object 3001 is an ordinary text object, which does not store any value in its index object ID. The synchronization object 3002 stores “1”, as a value representing the object ID of the text object 3001, in its index object ID, because the index object of the synchronization object 3002 is the text object 3001.

As the text object 3001 serves as the index object of the synchronization object 3002, the text object 3001 stores “2”, as a value representing the object ID of the synchronization object 3002, in its synchronization object ID.

The synchronization object 3003 designates the text object 3001 as the index object. Therefore, the synchronization object 3003 stores “1” in its index object ID.

The text object 3001 serves as the index object of two synchronization objects 3002 and 3003. Therefore, the text object 3001 stores “2” and “3” in its synchronization object ID.

The synchronization object 3002 serves as the index object of the synchronization object 3004. Therefore, the synchronization object 3002 stores “4” in its synchronization object ID. The synchronization object 3004 stores “2” in its index object ID.

FIG. 31 is a flowchart illustrating an example procedure of data processing, which can be performed by the document processing apparatus, according to the present exemplary embodiment. FIG. 31 illustrates example processing for changing an ordinary text object to a synchronization object, which corresponds to the text attribute change processing in step S2702 illustrated in FIG. 27. More specifically, the processing illustrated in FIG. 31 is for changing a text attribute of the synchronization object so as to accord with the text attribute of the index object.

The present processing includes checking the presence of any font of the index object to reflect text attributes of the index object in text attributes of the synchronization object. If there is not any font of the index object, the present processing uses another font. If a highlight setting is set to the synchronization object, the present processing further includes reflecting the highlight setting and changing the size of the synchronization object according to the changed (highlighted) font.

In step S3101, the bookbinding application 104 identifies an object ID of the index object, which is stored in the index object ID, and acquires a text attribute F of the text object having the identified object ID.

In step S3102, the bookbinding application 104 determines whether the font of the text attribute F is present in the computer. If the bookbinding application 104 determines that the font of the text attribute F is present in the computer (YES in step S3102), the processing proceeds to step S3103. In step S3103, the bookbinding application 104 stores the font of the text attribute F as a font applied to the text attribute of the synchronization object, and processing proceeds to step S3107.

If the bookbinding application 104 determines that the font of the text attribute F is not present in the computer (NO in step S3102), the processing proceeds to step S3104. In step S3104, the bookbinding application 104 determines whether any font similar to the font of the text attribute F is present in the computer. In this case, the similarity of fonts can be determined based on, for example, a matching degree in attribute (e.g., pitch and/or style, or font family). A method for determining the similarity based on features of font images can be also used.

If the bookbinding application 104 determines that the font similar to the font of the text attribute F is present in the computer (YES in step S3104), the processing proceeds to step S3105. In step S3105, the bookbinding application 104 stores the similar font as the font applied to the text attribute of the synchronization object, and processing proceeds to step S3107).

If the bookbinding application 104 determines that the font similar to the font of the text attribute F is not present in the computer (NO in step S3104), the processing proceeds to step S3106. In step S3106, the bookbinding application 104 stores a default font as the font applied to the text attribute of the synchronization object, and processing proceeds to step S3107. In this case, the default font can be automatically selected by the OS or can be arbitrarily designated by a user.

In step S3107, the bookbinding application 104 equalizes remaining text attributes (other than the font) of the synchronization object with the text attributes of the index object.

Thus, all the attributes (e.g., text style/size/color and character decoration) of the synchronization object are equalized with those of the index object. If one text object has two or more text attributes, a representative text attribute can be selected as a target attribute to be equalized between the synchronization object and the index object. For example, the text attribute of a head character or the text attribute used for many characters can be selected as a representative text attribute.

In step S3108, the bookbinding application 104 determines whether the synchronization object includes highlight setting as synchronization setting. If the bookbinding application 104 determines that the synchronization object includes highlight setting (YES in step S3108), the processing proceeds to step S3109. In step S3109, the bookbinding application 104 changes the text attributes according to the highlight setting, and processing proceeds to step S3110. If the bookbinding application 104 determines that that the synchronization object does not include the highlight setting (NO in step S3108), processing proceeds to step S3110.

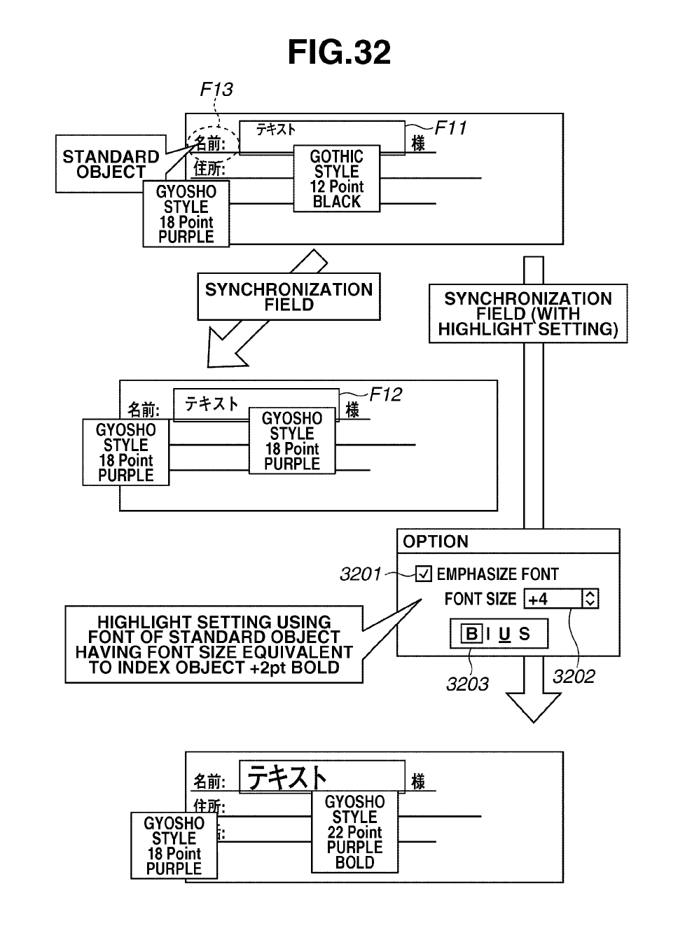

FIG. 32 illustrates an example document editing performed on the user interface displayed on the CRT 210 illustrated in FIG. 2. FIG. 32 illustrates a document editing state on the user interface usable for the highlight setting, including the synchronization field F12 and the index object F13. The index object F13 is a text object, which is Gyosho in font style, 18 point in font size, and purple in font color. An object initially placed in the field F11 is a text object, which is Gothic in font style, 12 point in font size, and black in font color.

In FIG. 32, a check box 3201 enables users to change the setting contents of the highlight setting.

A user interface 3202 enables users to input a change amount in font size relative to the font size of the index object.

For example, if a value “+4” is input in the user interface 3202 when the font size applied to the index object F13 is 10 point, the font size of the synchronization object to be placed in the synchronization field F12 is set to 14 point.

A user interface 3203 may enable users to designate a style, such as a preselected and/or desired style. For example, when the font style in the index object F13 is not bold, the font style for the synchronization object to be placed in the synchronization field F12 can be set to bold. When the highlight setting becomes effective, the text to be finally placed in the synchronization field F12 through the synchronization processing can be adjusted to Gyosho in font style, 22 point in font size, and purple in font color.

Similar user interfaces can be provided to enable users to apply highlight setting to the character decoration and the character spacing.

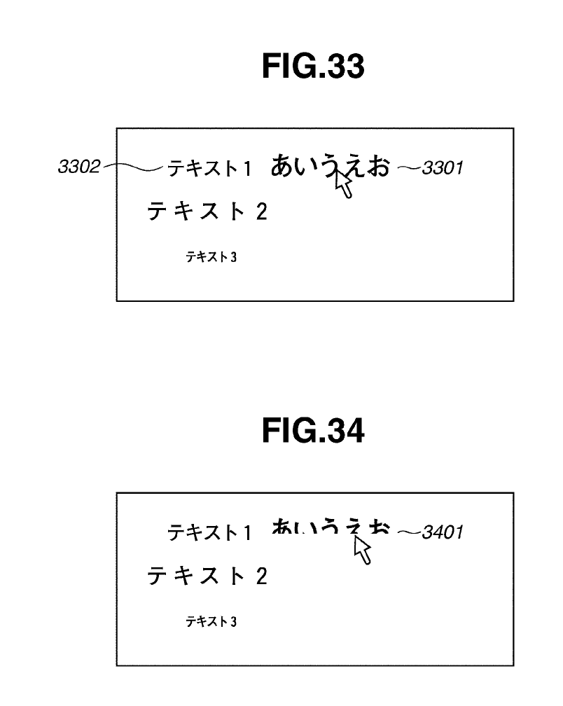

FIGS. 33 and 34 illustrate example text objects having been subjected to the highlight setting performed by the information processing apparatus according to the present exemplary embodiment.

FIGS. 33 and 34 illustrate synchronization objects having been subjected to the highlight setting.

In FIG. 33, a synchronization object 3301 having been subjected to the highlight setting is positioned next to its index object 3302. For example, the index object 3302 is Soeikaku Gothic in font style and 18 point in font size.

The synchronization object 3301 has the font size increased by +4 point as a result of the highlight setting. Namely, the font size of the synchronization object 3301 is 22 point (=18 point+4 point).

In step S3110, the bookbinding application 104 compares the height of the font size applied to the synchronization object with the height of a text area in an object area for the synchronization object, and determines whether the font size is greater than the text area. In this case, the text area is an area in which the text of the object area can be located.

If any margin is set for the object area, the text area is equal to a value obtained by subtracting the margin width from the height of the object area.

If no margin is set for the object area, there is no difference in size between the text area and the object area.

If the bookbinding application 104 determines that the height of the text area is smaller than the height of the font size applied to the synchronization object (YES in step S3110), then processing proceeds to step S3111. In step S3111, the bookbinding application 104 equalizes the height of text area with the height of the font size applied to the synchronization object, and processing is ended.

If the bookbinding application 104 determines that the height of the text area is not smaller than the height of the font size applied to the synchronization object (NO in step S3110), the bookbinding application 104 terminates the processing routine illustrated in FIG. 31.

If the processing in step S3111 is not performed, at least part of the text may be cut as illustrated in FIG. 34, because the height of the text area is smaller than the font size of synchronization object.

There may be a case where, if a text object is set as a synchronization object, the font size is enlarged compared to the initial state. Therefore, if the font of a text object is set to a maximum size in the initial state, the text may be partly cut as indicated in FIG. 34 (see synchronization object 3401) if the text object is processed as the synchronization object. To avoid these phenomena, the bookbinding application 104 may perform the processing of steps S3110 and S3111.

FIG. 35 is a flowchart illustrating an example procedure of data processing, which can be performed by the document processing apparatus, according to the present exemplary embodiment. FIG. 35 illustrates example processing for changing an ordinary text object to a synchronization object, which corresponds to the object position change processing performed in step S2703 illustrated in FIG. 27. More specifically, the processing (synchronization processing) illustrated in FIG. 35 is for changing the font baseline of the synchronization object so as to accord with the font baseline of the index object. The bookbinding application 104 may perform the following example processing for adjusting the layout position of an object to be input in the synchronization field based on the layout position (e.g., font baseline) of the index object.

The present processing includes obtaining a difference in baseline position between the index object and the synchronization object and changing the position of the synchronization object based on the obtained information to eliminate the difference between the baselines of two objects. Examples of processing in each step are described below.

In step S3501, the bookbinding application 104 acquires a font baseline BBL of the index object. In step S3502, the bookbinding application 104 subtracts the font baseline of the first line of the synchronization object from the font baseline BBL of the index object and stores the obtained value in a temporary storage area N.

If the index object is a text of two or more lines, the bookbinding application 104 can use any one of the plurality of lines.

In this case, a descender line or an ascender line of a font can be used instead of using the baseline of the font.

In step S3503, the bookbinding application 104 adds the value stored in the temporary storage area N to the position information representing the vertical coordinate value of the synchronization object. Thus, the position of the synchronization object can be equalized with the font baseline of the index object.

In step S3504, the bookbinding application 104 determines whether the area of the synchronization object is overlapped with the area of the index object.

In this case, an object area or a text area of the object can be used as the area used in the determination of step S3504.

If the bookbinding application 104 determines that the area of the synchronization object is overlapped with the area of the index object (YES in step S3504), the processing proceeds to step S3505. In step S3505, the bookbinding application 104 changes the position of the synchronization object to eliminate any overlap between the synchronization object and the index object. Then, the bookbinding application 104 terminates the processing routine illustrated in FIG. 35.

If the bookbinding application 104 determines that the area of the synchronization object is not overlapped with the area of the index object (NO in step S3504), the bookbinding application 104 terminates the processing routine illustrated in FIG. 35.

More specifically, in step S3505, the bookbinding application 104 shifts the synchronization object in the horizontal direction if the synchronization object is expressed by the horizontal writing, and shifts the synchronization object in the vertical direction if the synchronization object is expressed by the vertical writing. The shift direction of the synchronization object can be determined by considering the shortness in distance to shift to eliminate the overlap between the synchronization object and the index object.

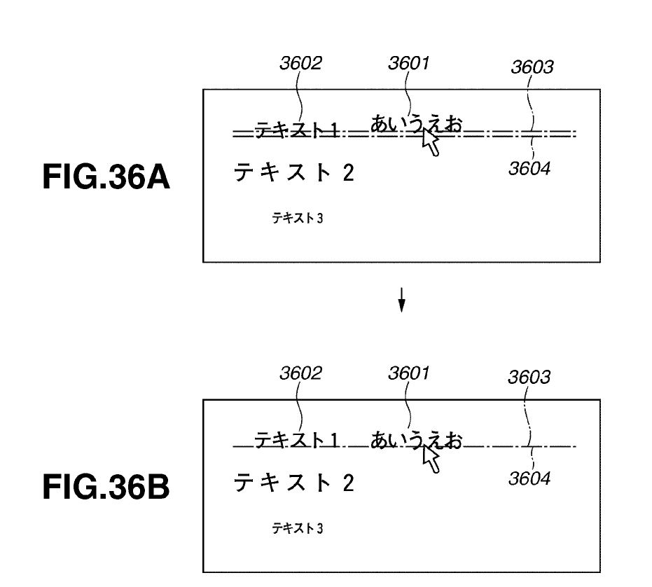

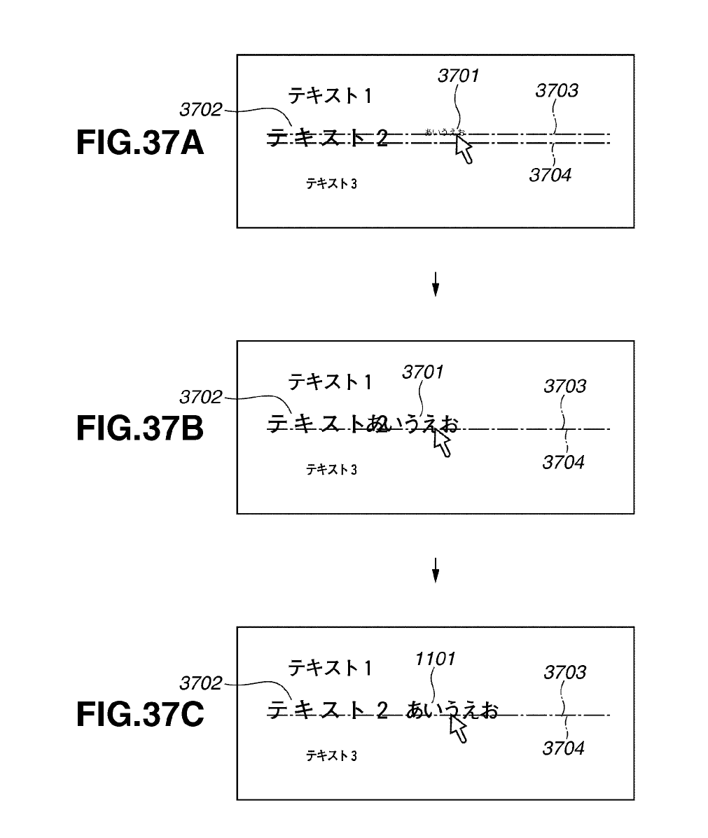

Detailed contents of the processing illustrated in FIG. 35 are described below with reference to example editing states of FIGS. 36A and 36B and FIGS. 37A to 37C.

FIGS. 36A and 36B and FIGS. 37A to 37C illustrate example states in the object position change processing performed by the information processing apparatus according to the present exemplary embodiment.

First, as illustrated in FIG. 36A, a synchronization object 3601 is positioned next to its index object 3602.

In this case, the bookbinding application 104 subtracts a font baseline 3603 (or 3703 in FIG. 37A) of the synchronization object 3601 from a font baseline 3604 (or 3704 in FIG. 37A) of the index object 3602 to obtain a difference. The bookbinding application 104 adds the obtained difference to the position information of the synchronization object 3601. As a result, the font baseline 3603 of the synchronization object 3601 accords with the font baseline 3604 of the index object 3602 as illustrated in FIG. 36B.

FIGS. 37A to 37C illustrate example states of the synchronization object and the index object, which are partly overlapped with each other as a result of the text attribute adjusting processing.

In FIGS. 37A to 37C, a synchronization object 3701 is positioned next to its index object 3702.

Processing for the examples illustrated in FIGS. 37A and 37B is identical to the processing for the examples illustrated in FIGS. 36A and 36B.

If the synchronization object 3701 and the index object 3702 are overlapped at least partly as a result of changes in the text attribute and the text position, the present exemplary embodiment moves the synchronization object 3701 to separate it from the index object 3702 as illustrated in FIG. 37C.

More specifically, if any overlap between the synchronization object 3701 and the index object 3702 is detected, the bookbinding application 104 moves the synchronization object 3701 to the right along the baseline to eliminate the overlap.

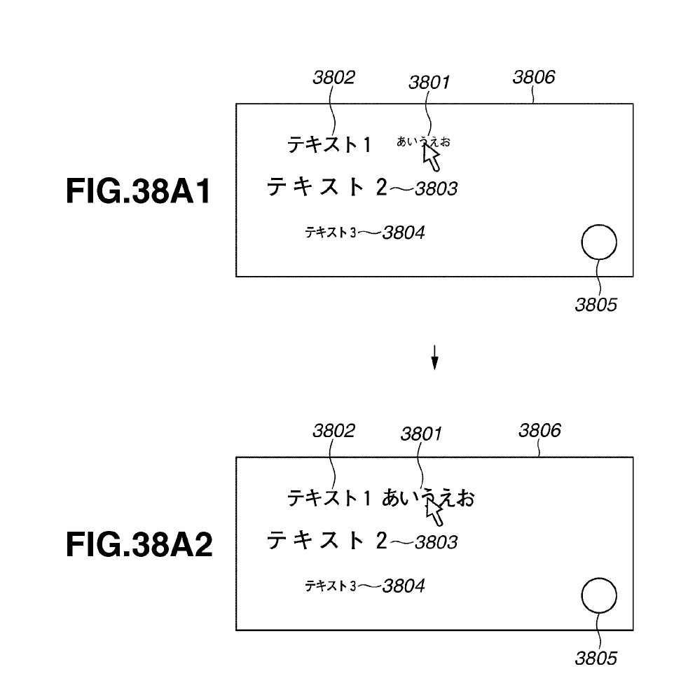

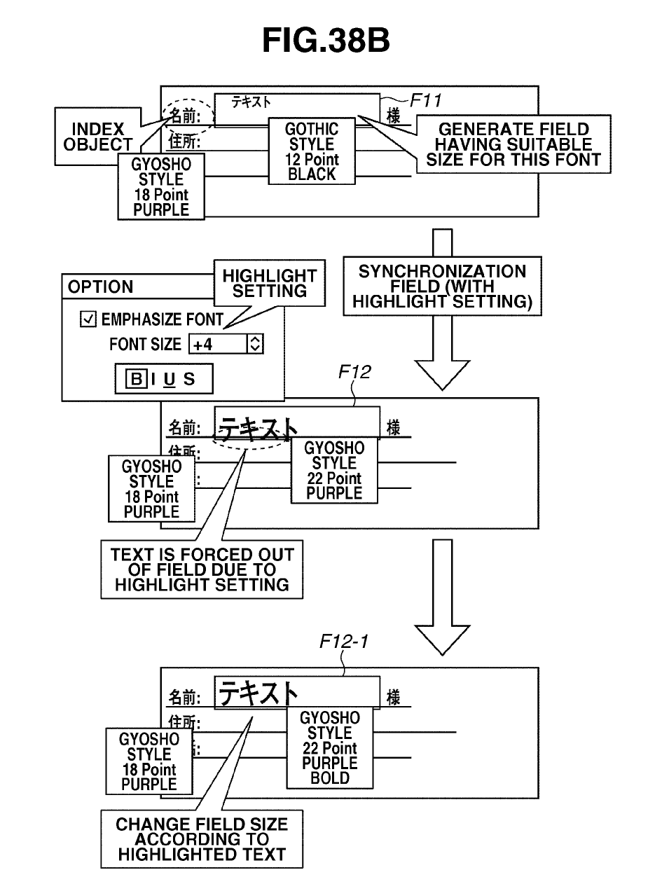

FIGS. 38A1 and 38A2 and FIG. 38B illustrate example states in the object editing processing performed by the information processing apparatus according to the present exemplary embodiment, which corresponds to the processing result of the steps illustrated in FIG. 27.

FIG. 38A1 illustrates a logical page 3806. FIG. 38A2 illustrates an example state of a text object 3801, which has been set as a synchronization object.

Four text objects 3801, 3802, 3803, and 3804 and a single graphic object 3805 are present on the logical page 3806.

Hence, if the text object 3801 in the synchronization field is set as a synchronization object, the bookbinding application 104 performs the processing of step S2701 to identify the closest text object among all text objects on the logical page. If the font baseline is set as the reference position, the bookbinding application 104 selects the index object 3802 (one of the text objects) as the closest text object (i.e., as the index object).

In this case, the graphic object 3805 is not a text object and cannot be a target to be retrieved.

Then, the bookbinding application 104 acquires text attributes of the index object 3802, which can be applied to the synchronization object.

Then, the bookbinding application 104 changes the position of the text object 3801 (synchronization object). As a result, the font baseline of the text object 3801 accords with the font baseline of the index object 3802. FIG. 38B illustrates an example setting of the synchronization object resulting from the above-described field size adjustment processing.

If the highlight setting illustrated in FIG. 32 is applied to the text of the synchronization field F12, the highlighted text may not be completely accommodated in the synchronization field F12.

Hence, as illustrated in FIG. 38B, when the highlight setting illustrated in FIG. 32 becomes effective, the text to be placed in the synchronization field F12 through the synchronization processing can be adjusted to Gyosho in font style, 22 point in font size, and purple in font color.

In this case, the bookbinding application 104 determines whether the text highlighted in the synchronization processing is completely accommodated in the synchqronization field F12. If the bookbinding application 104 determines that the highlighted text cannot be completely accommodated in the synchronization field F12, the bookbinding application 104 changes the size of the synchronization field F12 (i.e., creases a synchronization field F12-1) so that the highlighted text can be completely accommodated in the synchronization field.

Thus, as illustrated in FIG. 38B, the highlighted text is located in the synchronization field F12-1 having a changed size.

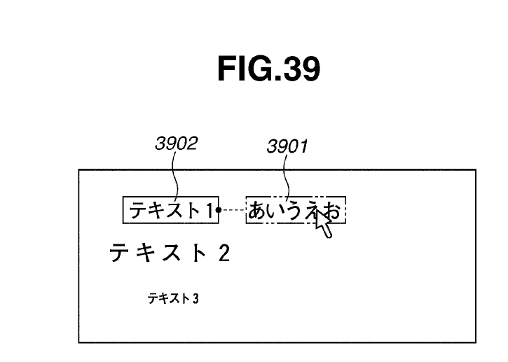

FIG. 39 illustrates an example state in the object editing processing performed by the document processing apparatus according to the present exemplary embodiment. FIG. 39 illustrates a display state of the logical page including the synchronization object.

An object, if designated as the synchronization object, is explicitly displayed in relationship with a corresponding index object as illustrated in FIG. 39.

For example, a synchronization object 3901 and an index object 3902 are linked each other using a line having a rounded end indicating the index object 3902.

Next, example processing for shifting the object position is described. The object located in the generated synchronization field can be referred to as the synchronization object.

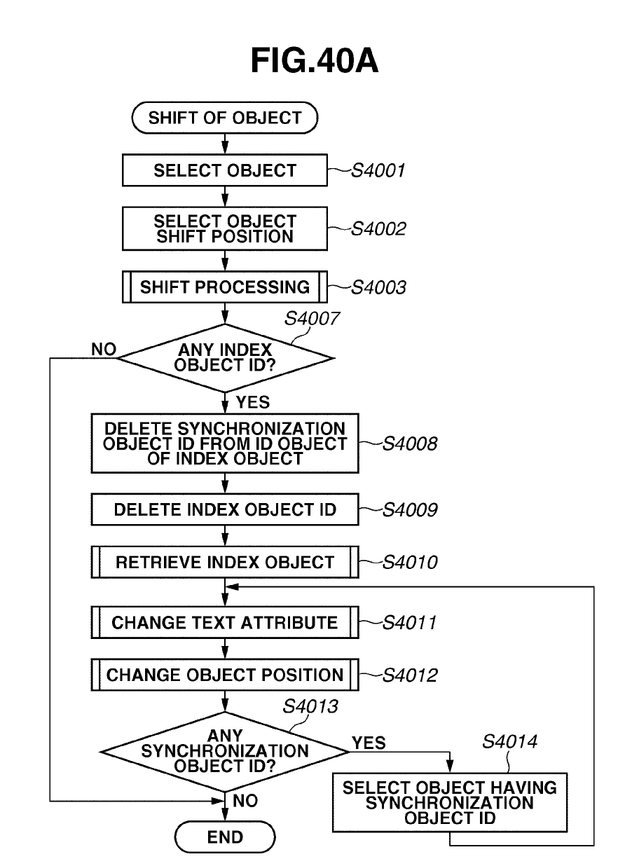

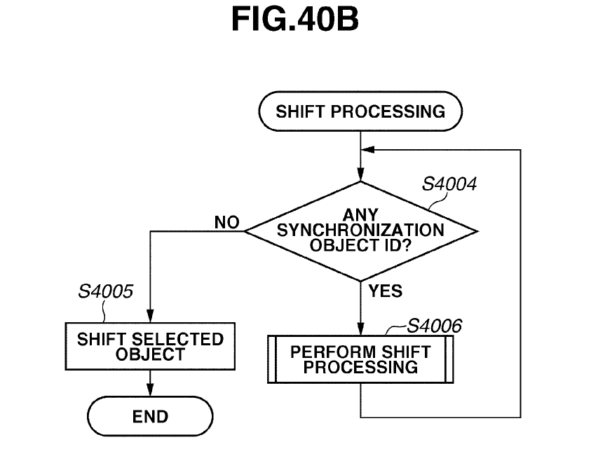

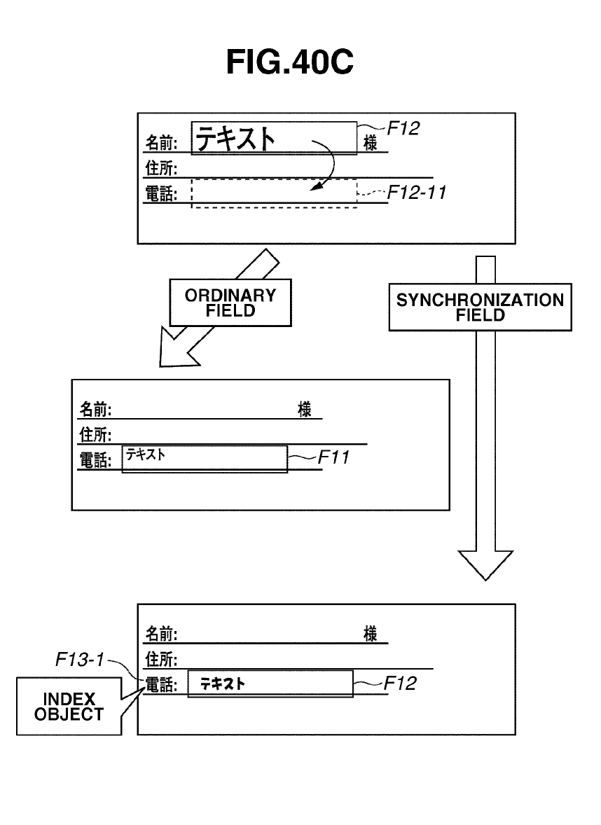

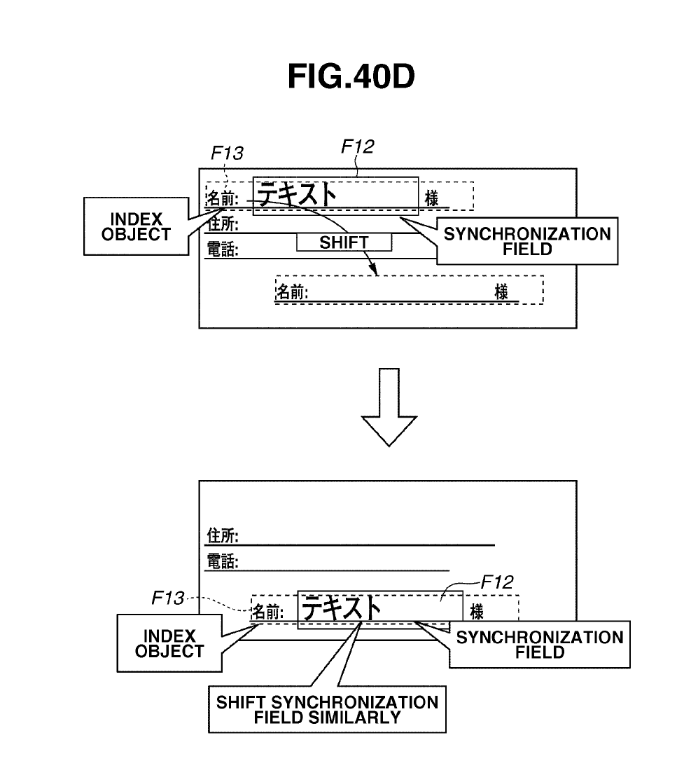

FIG. 40A is a flowchart illustrating an example procedure of data processing, which can be performed by the document processing apparatus, according to the present exemplary embodiment. FIG. 40A illustrates example processing (first shift processing) for setting an ordinary text object as a synchronization object and shifting the synchronization object.

The present processing includes changing the position information of an object selected by a user. If the selected object is an index object of another object, the processing includes shifting a synchronization object, which designates the selected object as the index object, according to the shift movement of the synchronization field, by the same shift amount. If the selected object is the synchronization object, the processing includes newly retrieving an index object at the shift completion position and performing shift processing for the text information and the object position according to the retrieved index object.

Therefore, in the shift processing illustrated in FIG. 40A, the object serving as a target to be shifted can be the synchronization object or the index object. In each case, example processing to be performed in respective steps of the flowchart is described below.

In step S4001, an object is selected based on a user's operation. Hereinafter, the object selected in step S4001 is referred to as the “selected object.” In step S4002, a shift position of the selected object is designated based on a user's operation. In step S4003, the bookbinding application 104 performs shift processing for changing the position of the object according to the flowchart illustrated in FIG. 40B.

FIG. 40B is a flowchart illustrating an example procedure of data processing, which can be performed by the document processing apparatus, according to the present exemplary embodiment. FIG. 40B illustrates details of the shift processing illustrating in step S4003 of FIG. 40A.

In step S4004, upon starting the shift processing, the bookbinding application 104 determines whether any synchronization object ID is set to the selected object. If the bookbinding application 104 determines that a value indicating the synchronization object ID is stored (YES in step S4004), the processing proceeds to step S4006. In step S4006, the bookbinding application 104 shifts an object having an object ID that is identical to the synchronization object ID. After completing the shift processing in step S4006, the processing returns to step S4004 to check the presence of any other synchronization object ID of the selected object.

If the processing of steps S4004 and S4005 has been completed for all synchronization object IDs, i.e., if the bookbinding application 104 determines that there is not any synchronization object ID (NO in step S4004), the processing proceeds to step S4005. In step S4005, the bookbinding application 104 changes the position information of the selected object and terminates the processing routine illustrated in FIG. 40B. Then, the processing proceeds to step S4007 and subsequent steps illustrated in FIG. 40A.

In step S4007, the bookbinding application 104 determines whether any index object ID is set to the selected object. If the bookbinding application 104 determines that the index object ID of the selected object is not present (NO in step S4007), the bookbinding application 104 terminates the processing routine illustrated in FIG. 40A. For example, an ordinary object stores no value in the index object ID. Therefore, the bookbinding application 104 terminates the above-described shift processing.

If in step S4007 the bookbinding application 104 determines that the index object ID of the selected object is present, i.e., when the selected object is the synchronization object, the bookbinding application 104 performs sequential processing in steps S4008 to S4013 and S4014.

More specifically, in step S4008, the bookbinding application 104 deletes a value identical to the selected object ID stored in the synchronization object ID of the object having the object ID of the index object ID.

In step S4009, the bookbinding application 104 deletes the value representing the index object ID of the selected object.

In step S4010, the bookbinding application 104 retrieves the index object. In step S4011, the bookbinding application 104 changes the text attribute. In step S4012, the bookbinding application 104 changes the position of the object. The processing to be performed in steps S4010 to S4012 is similar to the processing described with reference to FIG. 27.

In step S4013, the bookbinding application 104 determines whether any value is stored in the synchronization object ID of the selected object. If the bookbinding application 104 determines that there is a value stored in the synchronization object ID of the selected object (YES in step S4013), the processing proceeds to step S4014. In step S4014, the bookbinding application 104 designates, as a selected object, the synchronization object having an object ID that is identical to the synchronization object ID. Then, the processing returns to step S4011.

In step S4011, the bookbinding application 104 performs the text attribute change processing for a newly selected object. Then, in step S4012, the bookbinding application 104 changes the position of the newly selected object.

In step S4013, the bookbinding application 104 again determines whether any value is stored in the synchronization object ID of the newly selected object. In this case, the bookbinding application 104 determines that the newly selected object has no object ID.

In this manner, the bookbinding application 104 repeats the processing of steps S4014, S4011, and S4012 by the number of times corresponding to the total number of the synchronization object IDs of the object selected based on the user's operation.

If in step S4013 the bookbinding application 104 determines that no value is stored in the synchronization object ID (NO in step S4013), the bookbinding application 104 terminates the processing routine illustrated in FIG. 40A.

Next, the first shift processing for shifting the synchronization field is described below, in relation to the index object, with reference to an example illustrated FIG. 40C.

When the synchronization field is shifted, the bookbinding application 104 performs the index object retrieval processing again at the shift completion position and then performs the text attribute/position adjustment. Namely, the bookbinding application 104 newly performs the synchronization processing illustrated in FIG. 27. Hereinafter, example synchronization field shift processing is described below with reference to FIGS. 40A, 40B, and 40C.

First, in step S4001, an object is selected based on a user's operation. The mouse and the keyboard are generally known as example object selection units that enable users to perform click and key operations.

In step S4002, a shift position of the selected object is designated based on a user's operation. FIG. 40C illustrates an example shift position F12-11. In step S4003, the bookbinding application 104 performs the processing for shifting the object.

In the shift processing, the bookbinding application 104 determines whether any value is stored in the synchronization object ID of the selected object, as described in step S4004 of FIG. 40B. If the bookbinding application 104 determines that the synchronization object ID of the selected object does not store any value (NO in steps S4004), the processing proceeds to step S4005. In step S4005, the bookbinding application 104 shifts the selected object, and processing proceeds to step S4007.

If in step S4004 it is determined that the synchronization object ID is stored (YES in step S4004), there is an object that designates the selected object as an index object, and processing proceeds to step S4006. Therefore, in step S4006, the bookbinding application 104 shifts the synchronization object, although the processing is described below in detail, and processing returns to step S4004.

In step S4007 illustrated in FIG. 40A, the bookbinding application 104 determines whether the selected object stores any index object ID. In this case, if the selected object is the synchronization object, the index object ID is present (YES in step S4007), and processing proceeds to step S4008. Therefore, in step S4008, the bookbinding application 104 deletes the value stored in the object ID of the object, selected as the synchronization object ID of the object having the object ID of the index object ID. Then, in step S4009, the bookbinding application 104 deletes the index object ID of the selected object.

Thus, the relevancy to the index object can be deleted. Then, in step S4010, the bookbinding application 104 retrieves the index object, i.e., newly retrieves the index object at the shift completion position.

As described above, FIG. 28 illustrates the detailed index object retrieval processing.

In step S4011, the bookbinding application 104 performs the text attribute change processing. Then, in step S4012, the bookbinding application 104 performs the object position change processing.

As described above, FIG. 31 illustrates the detailed text attribute change processing and FIG. 35 illustrates the detailed object position change processing.

Next, in step S4013, the bookbinding application 104 determines whether any value is stored in the synchronization object ID of the selected object. If the synchronization object ID is stored (YES in step S4013), there is a synchronization object that designates the selected object as the index object, and processing proceeds to step S4014. Therefore, in step S4014, the bookbinding application 104 designates the synchronization object as a selected object. In steps S4011 and S4012, the bookbinding application 104 repetitively performs the text attribute change processing and the object position change processing, until no value remains in the synchronization object ID of the selected object (NO in step S4013), and processing is ended.

Through the above-described processing, when the synchronization object is shifted, the index object is retrieved again and the text attribute and the object position can be adjusted for the retrieved index object (see F13-1 in FIG. 40C).

More specifically, if a user shifts the synchronization field F12, the font attribute and the field position for the newly retrieved closest index object F13-1 can be automatically adjusted.

If the object is an ordinary field, a user may be required to individually adjust the font attribute and the field position for the shifted ordinary field.

Next, second shift processing for shifting the index object is described below with reference to FIGS. 40A, 40B, and 40D. In this case, the second shift processing is processing for shifting the synchronization field F12 together with the index object F13 by the same shift amount, because the index object F13 is the object designated by the synchronization field F12 as illustrated in FIG. 40D. The object to be placed in the synchronization field F12 can be referred to as the synchronization object.

In step S4001, an object is selected if the object is shifted by a user. In step S4002, a shift position of the selected object is designated based on a user's operation. Then, in step S4003, the bookbinding application 104 performs the object shift processing.

After starting the shift processing, in step S4004 illustrated in FIG. 40B, the bookbinding application 104 determines whether any value is stored in the synchronization object ID of the selected object. In this case, the index object F13 stores a value in the synchronization object ID (YES in step S4004), and processing proceeds to step S4006. If no value is stored in the synchronization object ID (NO in step S4004), processing proceeds to step S4005, where the selected object is shifted, and processing proceeds to step S4007.

In step S4006, the bookbinding application 104 performs the shift processing on the synchronization field F12 that has the object ID of the synchronization object ID, and processing returns to step S4004.

In this manner, by performing the processing recursively, the position of the synchronization field F12 can be adjusted according to the position of the index object F13 if the index object F13 of the synchronization field F12 is shifted. In the determination of step S4004, the bookbinding application 104 disregards any synchronization object, if it has been already subjected to the shift processing.

In other words, the bookbinding application 104 repeats the shift processing plural times corresponding to the total number of the synchronization object IDs.

The bookbinding application 104 performs the processing of steps S4007 to S4014 as described above.

In a case where the text attribute of the index object is changed, the processing can be performed in the same manner as the above-described index object shift processing.

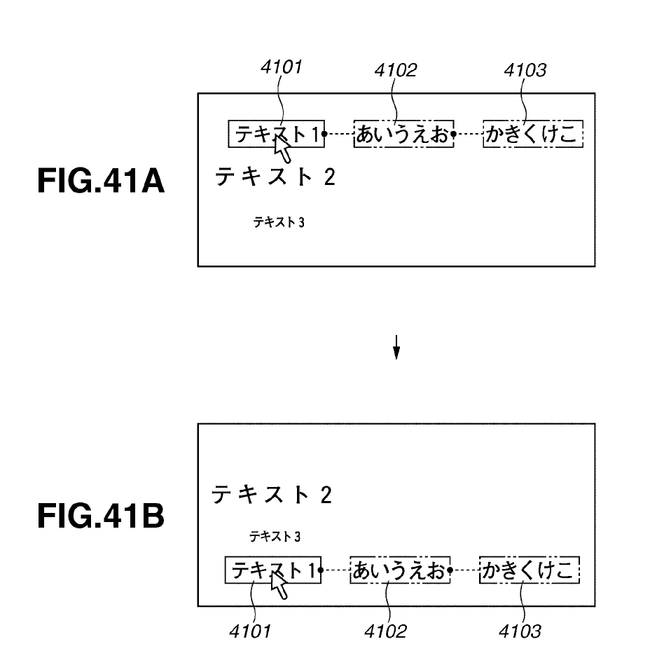

Example second shift processing for shifting the index object is described below with reference to editing states illustrated in FIGS. 41A and 41B.

FIGS. 41A and 41B illustrate example states in the synchronization field shift processing performed by the information processing apparatus according to an exemplary embodiment of the present invention.

In FIG. 41A, an index object 4101 is an index object of a synchronization object 4102 and the synchronization object 4102 is an index object of a synchronization object 4103.

FIG. 41A illustrates an example state where the shift processing is not yet performed. FIG. 41B illustrates an example state where the shift processing has been completed.

First, a user instructs processing for shifting the index object 4101.

Next, the information processing apparatus performs processing for shifting the synchronization object 4102 of the index object 4101.

Moreover, the information processing apparatus performs processing for shifting the synchronization object 4103, which designates the synchronization object 4102 as an index object. Then, as no value is stored in the synchronization object ID of the synchronization object 4103, the information processing apparatus stops the shift processing.

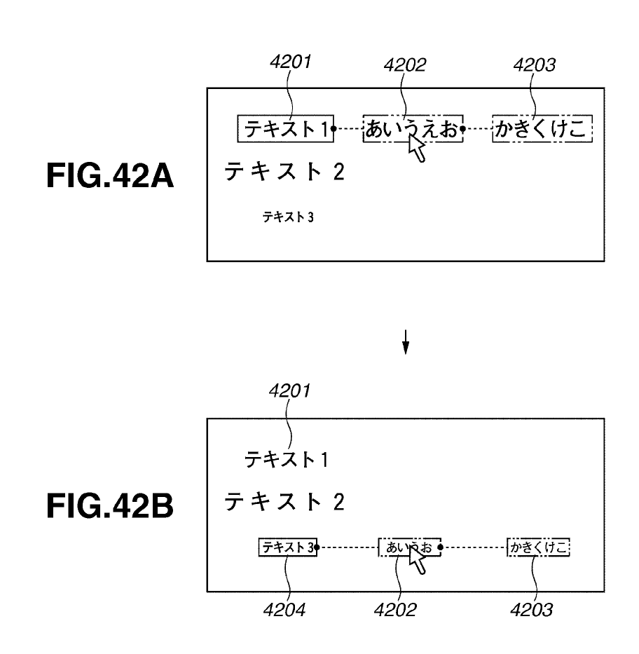

FIGS. 42A and 42B illustrate example states in the synchronization field shift processing performed by the information processing apparatus according to an exemplary embodiment of the present invention. In the present exemplary embodiment, an object placed in the synchronization field is referred to as the synchronization object.

In FIGS. 42A and 42B, an index object 4201 is an index object of a synchronization object 4202 and the synchronization object 4202 is an index object of a synchronization object 4203.

FIG. 42A illustrates an example state where the shift processing is not yet performed. FIG. 42B illustrates an example state where the shift processing has been completed.

A user instructs processing for shifting the synchronization object 4202. Then, the bookbinding application 104 retrieves the index object at a shift completion position.

The bookbinding application 104 selects an index object 4204 as a new index object, which is identified as a closest object based on the retrieval processing performed at the shift completion position.

Then, the bookbinding application 104 performs processing for adjusting the text attribute and the object position of the synchronization object 4202 according to the text attribute and the object position of the index object 4204.

The bookbinding application 104 further performs processing for adjusting the text attribute and the object position of the synchronization object 4203 according to the text attribute and the object position of the synchronization object 4202 (which serves as the index object of the synchronization object 4203).

In the above-described description, the text object is an object to be processed. However, similar processing can also be performed on a text box. Therefore, the text box can be designated as a synchronization object.

Any other object can be designated as a synchronization object, if the position of the object is changeable and the object includes any text attribute and a character string to be displayed.

For example, in the variable printing (i.e., a printing performed by changing at least part of characters and images for each print product), a document processing apparatus generates a variable text field in which characters to be replaced can be inserted. In this case, the variable text field can be set as a synchronization object because the variable text field possesses position information and text attributes.

The object, which can serve not only as a synchronization object but also as an index object, is not limited to the text object. Any other object and any variable text field, having position information and text attributes, can be also used.

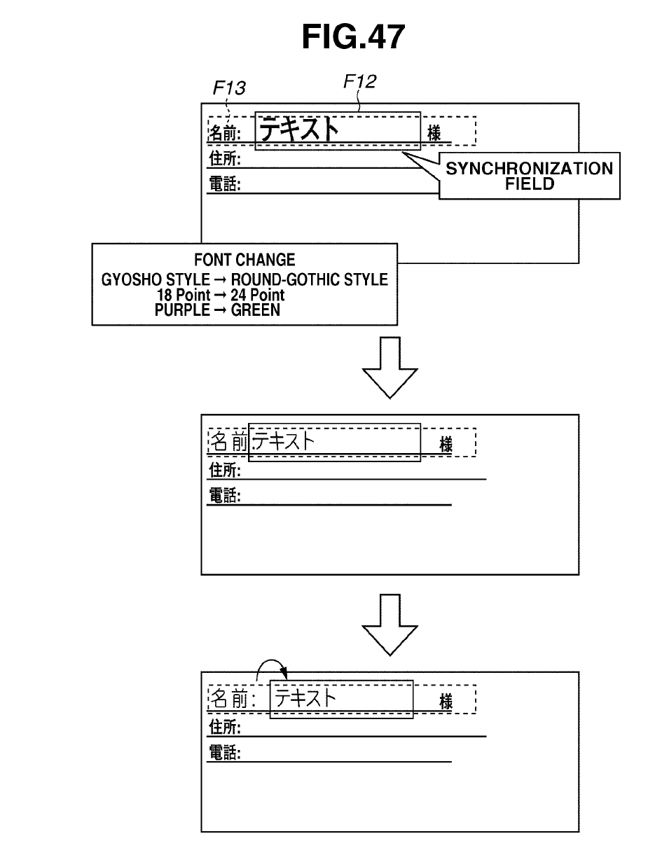

FIG. 47 illustrates an example state in the document processing performed by the document processing apparatus according to the present exemplary embodiment. FIG. 47 illustrates an example change in the attribute of a synchronization object placed in the synchronization field according to a change in the attribute of an index object associated with the synchronization object.

The index object F13 illustrated in FIG. 47 is the object selected based on a user's operation. The property screen (not illustrated) enables the user to change the text attribute of the index object F13. More specifically, the user changes the font style from Gyosho to round-Gothic, changes the character size from 18 point to 24 point, and changes the font color from purple to green.

When the attribute of the index object F13 is changed, the bookbinding application 104 changes the attribute of the synchronization object placed in the synchronization field, which is associated with the index object F13, so that the attribute of the synchronization object accords with the attribute of the index object F13. However, if the changed attribute of the index object is directly applied to the synchronization object, the position and the size of the synchronization object may change.

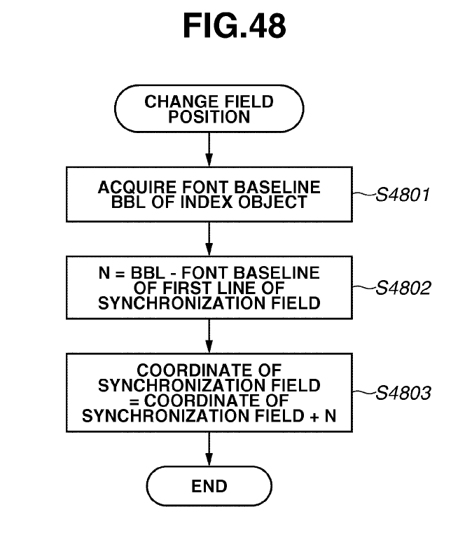

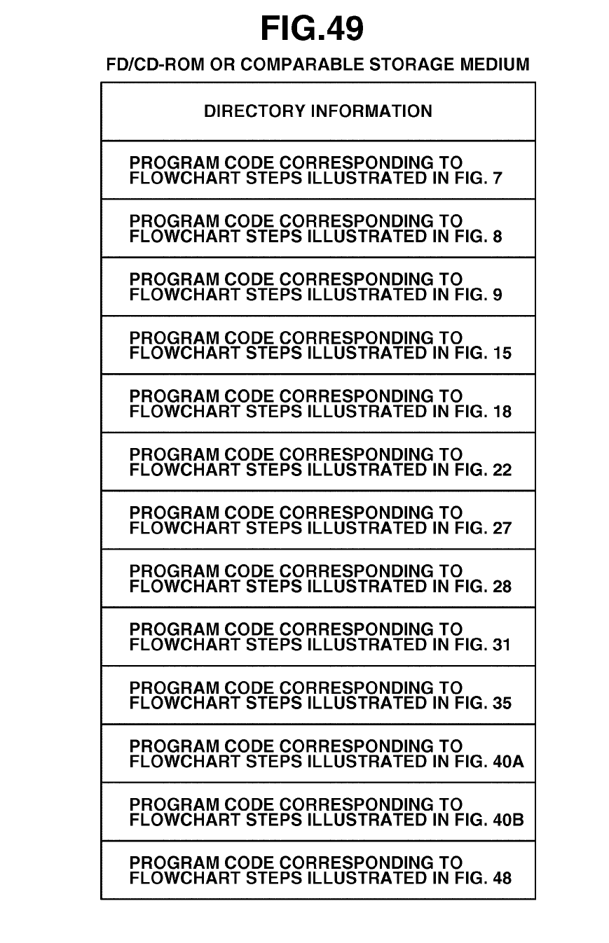

For example, if the bookbinding application 104 determines that characters of the index object are overlapped in position with characters of in the synchronization field, the bookbinding application 104 shifts the characters of the synchronization field in the horizontal direction to eliminate any overlap between the characters in the index object and the synchronization field as illustrated in FIG. 47. In this case, the font baseline serves as a reference line for the shift processing. Example field position change processing is described below with reference to a flowchart illustrated in FIG. 48.

FIG. 48 is a flowchart illustrating an example procedure of data processing, which can be performed by the document processing apparatus, according to the present exemplary embodiment. FIG. 48 illustrates example processing for shifting the synchronization field in the horizontal direction to eliminate any overlap between characters in the synchronization field and the index object.

In step S4801, the bookbinding application 104 acquires a font baseline BLL of the index object F13 illustrated in FIG. 47 from the font information. In step S4802, the bookbinding application 104 subtracts the value representing the font baseline of the first line in the synchronization field F12 from the value of the acquired baseline BLL.

In step S4803, the bookbinding application 104 adds the subtraction value N to the coordinate value of the synchronization field (in the state prior to the shifting) and terminates the processing routine illustrated in FIG. 48.

Through the processing illustrated in FIG. 48, the baseline of the synchronization field F12 coincides with the font baseline of the index object.

After completing the above-described adjustment of the baseline, the bookbinding application 104 may shift the synchronization field (changes the layout coordinate of the head character placed in the synchronization field F12), so that the head character in the synchronization field F12 is sufficiently spaced from the tail character of the index object F13.

An example configuration of data processing programs, which can be read by the document processing apparatus according to an exemplary embodiment of the present invention, is described below with reference to a memory map illustrated in FIG. 49.

FIG. 49 illustrates an embodiment of a memory map of a storage medium, which can store various data processing programs readably by the document processing apparatus, according to an exemplary embodiment of the present invention.

Although not illustrated in the drawing, the storage medium can store management information for the programs stored in the storage medium, such as for example version information, creator name, and information relevant to the OS that reads the programs, e.g., icons discriminately displaying the programs.

Furthermore, in one version a directory of the storage medium can manage data belonging to various programs. Moreover, the storage medium can store a program to be used to install various programs on a computer and a decompression program if the installed program is compressed.

Embodiments of software program code for realizing the functions of the above-described exemplary embodiments, which are described with reference to the flowcharts illustrated in FIGS. 7, 8, 9, 15, 18, 22, 27, 28, 31, 35, 40A, 40B, and 48, are installable on a system or an apparatus including various devices. In this case, according to the present invention, any information group including the programs can be supplied to an output apparatus using for example a storage medium (e.g., CD-ROM, flash memory, or FD) or via a network from an external storage medium.

A storage medium storing the software program code that can realize functions of the above-described exemplary embodiments can be supplied to a system or an apparatus. A computer (or CPU or micro-processing unit (MPU)) in the system or the apparatus can execute the programs to operate the devices to realize functions of the above-described exemplary embodiments.

In this case, the program code itself read out of the storage medium can realize novel functions of the present invention. The storage medium storing the program code can comprise a configuration according to the present invention.

Accordingly, various types of programs, such as for example object code, interpreter program, and OS script data, may be usable if they possess comparable functions.

A storage medium supplying the program can be selected for example from any one of a floppy disk, a hard disk, an optical disk, a magneto-optical (MO) disk, a compact disc-ROM (CD-ROM), a CD-recordable (CD-R), a CD-rewritable (CD-RW), a magnetic tape, a nonvolatile memory card, a ROM, and a digital versatile disc (DVD (DVD-ROM, DVD-R)).

In this case, the program code itself read out of the storage medium can comprise computer-executable instructions that realize functions of the above-described exemplary embodiments. The storage medium storing the program code can comprise a configuration according to aspects of the present invention.

The method for supplying the programs can include, for example, accessing a website on the Internet using a browsing function of a client computer, when the website allows each user to download the computer program of the present invention, or compressed files of the programs having automatic installing functions, to a hard disk or other recording medium of the user. The program code for programs in accordance with exemplary embodiments of the present invention may also be dividable into a plurality of files so that respective files are downloadable from different websites. Namely, in one version, the present invention may encompass World Wide Web (WWW) servers and File Transfer Protocol (FTP) servers that allow numerous users to download the program files so that their computers can realize functions or processes according to the exemplary embodiments of the present invention.

In one version, enciphering the programs in accordance with aspects of the present invention and storing the enciphered programs on a CD-ROM or a comparable recording medium may be an exemplary method when the programs in accordance of the present invention are distributed to the users. The authorized users (i.e., users satisfying predetermined conditions) may be allowed to download key information from a website on the Internet. The users can decipher the programs with the obtained key information and can install the programs on their computers. When the computer reads and executes the installed programs, the computer can realize the functions of the above-described exemplary embodiments.

Moreover, in one version, an operating system (OS) or other application software running on a computer can execute part or all of actual processing based on instructions of the programs to realize functions of the above-described exemplary embodiments of the present invention.

Additionally, in one version program code read out of a storage medium can be written into a memory of a function expansion board inserted in a computer or into a memory of a function expansion unit connected to the computer. In this case, based on instructions of the program code, a CPU provided on the function expansion board or the function expansion unit can execute part or all of the processing to realize functions of the above-described exemplary embodiments of the present invention.

According to one aspect of the invention, the data processing according to the exemplary embodiments of the present invention can synchronize the attribute(s) set for an input object with the attribute(s) of any object located on the same page.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-014191 filed Jan. 24, 2008, which is hereby incorporated by reference herein in its entirety.

What is claimed is:

1. A document processing apparatus configured to perform document editing processing for locating a plurality of objects on a page, the document processing apparatus comprising:
a generation unit configured to generate a synchronization field for an object to be located according to an attribute of any one of the objects located on the page;
a retrieval unit configured to retrieve an index object from the page as a target having the attribute to be applied to the generated synchronization field; and
a reflecting unit configured to reflect an attribute of the index object retrieved by the retrieval unit and a layout position of the index object in an attribute and a layout position of the object to be located in the synchronization field.

2. The document processing apparatus according to claim 1, further comprising:
a highlight setting unit configured to perform a specific highlight setting on the object in the attribute and layout position of which the attribute and the layout position of the index object retrieved by the retrieval unit are reflected by the reflecting unit; and
a field size adjustment unit configured to adjust a size of the synchronization field based on the specific highlight setting performed by the highlight setting unit.

3. The document processing apparatus according to claim 1, further comprising a first shifting unit configured to change a layout position of the synchronization field on the page,
wherein the reflecting unit is configured to reflect, after the synchronization field has been shifted by the first shifting unit, an attribute of an index object newly retrieved by the retrieval unit and a layout position of the newly retrieved index object in the attribute and the layout position of the object to be located in the synchronization field.

4. The document processing apparatus according to claim 1, further comprising a second shifting unit configured to move the index object on the page,
wherein the reflecting unit is configured to move the synchronization field corresponding to the index object according to a movement of the index object moved by the second shifting unit.

5. The document processing apparatus according to claim 1, further comprising a changing unit configured to change the attribute of the index object,
wherein if the attribute of the index object is changed by the changing unit, the reflecting unit is configured to change the attribute of the corresponding synchronization field according to the changed attribute of the index object.

6. The document processing apparatus according to claim 1, wherein the object includes a text object.

7. The document processing apparatus according to claim 1, wherein the retrieval unit is configured to retrieve an object located at a position closest to the generated synchronization field as the index object.

8. A method for performing document editing processing to locate a plurality of objects on a page, the method comprising:
generating a synchronization field for an object to be located according to an attribute of any one of the objects located on the page;
retrieving an index object from the page as a target having the attribute to be applied to the generated synchronization field; and
reflecting an attribute of the retrieved index object and a layout position of the index object in an attribute and a layout position of the object to be located in the synchronization field.

9. The method according to claim 8, further comprising:
performing a specific highlight setting on the object in the attribute and layout position of which the attribute and the layout position of the retrieved index object are reflected; and
adjusting a size of the synchronization field based on the specific highlight setting.

10. The method according to claim 8, further comprising:
changing a layout position of the synchronization field on the page; and
reflecting, after the synchronization field has been shifted, an attribute of a newly retrieved index object and a layout position of the newly retrieved index object in the attribute and the layout position of the object to be located in the synchronization field.

11. The method according to claim 8, further comprising:
moving the index object on the page; and
moving the synchronization field corresponding to the index object according to a movement of the index object.

12. The method according to claim 8, further comprising:
changing the attribute of the index object; and
if the attribute of the index object is changed, changing the attribute of the corresponding synchronization field according to the changed attribute of the index object.

13. The method according to claim 8, wherein the object includes a text object.

14. The method according to claim 8, further comprising retrieving an object located at a position closest to the generated synchronization field as the index object.

15. A computer-readable storage medium storing a computer-executable control program to perform document editing processing for locating a plurality of objects on a page, the control program comprising:
computer-executable instructions for generating a synchronization field for an object to be located according to an attribute of any one of the objects located on the page;
computer-executable instructions for retrieving an index object from the page as a target having the attribute to be applied to the generated synchronization field; and
computer-executable instructions for reflecting an attribute of the retrieved index object and a layout position of the index object in an attribute and a layout position of the object to be located in the synchronization field.

16. The computer-readable storage medium according to claim 15, wherein the control program further comprises:
computer-executable instructions for performing a specific highlight setting on the object in the attribute and layout position of which the attribute and the layout position of the retrieved index object are reflected; and
computer-executable instructions for adjusting a size of the synchronization field based on the specific highlight setting.

17. The computer-readable storage medium according to claim 15, wherein the control program further comprises:
computer-executable instructions for changing a layout position of the synchronization field on the page; and
computer-executable instructions for reflecting, after the synchronization field has been shifted, an attribute of a newly retrieved index object and a layout position of the newly retrieved index object in the attribute and the layout position of the object to be located in the synchronization field.

18. The computer-readable storage medium according to claim 15, wherein the control program further comprises:
computer-executable instructions for moving the index object on the page; and
computer-executable instructions for moving the synchronization field corresponding to the index object according to a movement of the index object.

19. The computer-readable storage medium according to claim 15, wherein the control program further comprises:
computer-executable instructions for changing the attribute of the index object; and
computer-executable instructions for, if the attribute of the index object is changed, changing the attribute of the corresponding synchronization field according to the changed attribute of the index object.

20. The computer-readable storage medium according to claim 15, wherein the object includes a text object.

21. The computer-readable storage medium according to claim 15, wherein the control program further comprises computer-executable instructions for retrieving an object located at a position closest to the generated synchronization field as the index object.
